(19) United States
(12) Patent Application Publication
(10) Pub. No.: US 2025/0265389 A1
(43) Pub. Date: Aug. 21, 2025

(54) SOLID STRUCTURE DEFORMATION AND DAMAGE ANALYSIS METHOD BASED ON QUASI-BOND FINITE ELEMENT METHOD

(71) Applicant: HOHAI UNIVERSITY, Nanjing (CN)

(72) Inventors: Qizhi ZHU, Nanjing (CN); Renjie ZHANG, Nanjing (CN); Tingyu ZHOU, Nanjing (CN); Wu LIU, Nanjing (CN)

(73) Assignee: HOHAI UNIVERSITY, Nanjing (CN)

(21) Appl. No.: 19/203,346

(22) Filed: May 9, 2025

(30) Foreign Application Priority Data
May 10, 2024 (CN) 202410573006.1

(51) Int. Cl. G06F 30/23; G06F 119/14

(52) U.S. Cl. CPC G06F 30/23; G06F 2119/14

(57) ABSTRACT

A solid structure deformation and damage analysis method based on a quasi-bond finite element method comprises: carrying out geometric modeling on a target structure body, and distribution and subdivision to generate a grid of a traditional finite element method; dividing the target structure body into a finite element region and a quasi-bond region, and calculating a finite element region system stiffness matrix and a quasi-bond region system stiffness matrix to obtain an overall stiffness matrix of the target structure body; setting a boundary condition for the target structure body, applying an external load, and calculating a system force matrix under current load and boundary state; and judging a quasi-bond breakage condition according to a node trial displacement, then calculating a node displacement of the structure body and an equivalent damage parameter at each node, and outputting cloud charts of a displacement field and an equivalent damage field.

### CROSS-REFERENCE TO RELATED APPLICATIONS

This application claims priority to Chinese Patent Application Ser. No. CN202410573006.1 filed on 10 May 202.

### TECHNICAL FIELD

The present invention belongs to the technical field of numerical analysis of structure deformation and damage, and particularly relates to a solid structure deformation and damage analysis method based on a quasi-bond finite element method.

### BACKGROUND

The prediction and simulation of progressive damage and breakage of materials and structures under an external load has an important application value in mechanical manufacturing, civil and hydraulic engineering, aerospace, rock and soil geology and other engineering fields, and is also a difficulty in research fields of solid mechanics and material science.

With the rapid development of computer technology, a large number of numerical analysis methods for structures have been put forward, wherein the prediction of breakage and crack propagation rules of materials by numerical simulation and calculation has gradually become a research hotspot. A method based on a continuum mechanics theory is usually used to simulate the evolution of stress field caused by micro-structure changes, such as a finite element method, a finite difference method and a Fourier spectrum method; and another method is to apply a material damage variable quantity to finite element analysis, wherein the characteristic of micro-crack propagation is the deterioration of element stiffness. A multi-scale damage model, a non-local damage theory, a gradiently enhanced softening model and a phase field damage model all belong to this category. However, this method cannot simulate a crack as a strong discontinuity surface.

Based on a challenge encountered by the method of continuum in characterizing the crack, a near-field dynamics method is developed by combining ideas of continuum mechanics and molecular dynamics. N ear-field dynamics is a continuum mechanics theory, which establishes a model based on an idea of non-local action and describes a mechanical behavior of material by an integral-differential equation. The near-field dynamics overcomes the grid dependence of traditional numerical methods based on the assumption of local continuity theoretically, which may naturally simulate a crack propagation process without introducing additional crack propagation criteria, but a non-local interaction may lead to the underestimation of stiffness of material surface. In addition, the problem of calculation cost caused by non-local particle interaction in a near-field dynamics model also needs to be solved urgently.

The Chinese patent application, application number: 2023116403586, titled: structural deformation and damage analysis method based on inter-force band finite element method, is the applicant's priority patent application, and is now referred to as a quasi-bond method for short. In this method, a standard finite element grid is used for spatial discretization, and the indirect transmission of node force is realized by constructing a representative force bond inside an element. On this basis, meso-mechanical properties of solid materials, such as elasticity and damage, are reflected by a bond-scale constitutive model and a bond failure model, and a damage and failure process of solid materials under a loading action is a result of orderly breakage of quasi-bond. Prominent numerical problems in near-field dynamics analysis, such as softening of inner boundary and unnatural coupling with finite element, can all be well solved. However, this quasi-bond method needs to traverse all quasi-bonds, and a large number of invalid operations will be carried out when generating a stiffness matrix and making a breakage judgment in continuum, thereby reducing the calculation efficiency.

### SUMMARY

The present invention aims to provide a solid structure deformation and damage analysis method based on a quasi-bond finite element method, which solves the technical problem that the calculation efficiency of the quasi-bond method is low in the prior art.

In order to solve the above technical problem, the following technical solution is used in the present invention.

A solid structure deformation and damage analysis method based on a quasi-bond finite element method comprising a non-transitory computer readable medium operable on a computer with memory for the solid structure deformation and damage analysis method based on a quasi-bond finite element method, and comprising program instructions for executing the following steps of:
step S1: carrying out geometric modeling on a target structure body Ω, and carrying out distribution and subdivision on a model boundary to generate a grid of a traditional finite element method, so as to obtain several elements and nodes;
step S2: presetting a fracture on the target structure body Ω, and dividing the target structure body Ω into a finite element calculation region Ω_{FEM} and a quasi-bond calculation region Ω_{QBM}, wherein a potential occurrence region of fracture and crack is located in the quasi-bond calculation region Ω_{QBM};
step S3: setting a boundary condition for the target structure body Ω, applying an external load, and calculating a force matrix F, a finite element region system stiffness matrix K̅_{FEM} and a quasi-bond region system stiffness matrix K̅_{QBM}, of the target structure body under the load and boundary state, and an overall stiffness matrix K̅ of the target structure body, K̅=K̅_{FEM}=K̅_{QBM};
step S4: setting the target structure body as an elastic material, calculating an initial node displacement vector u^{trial}, wherein the u^{trial} is equal to multiplication of an initial overall stiffness matrix of the target structure body and an initial force matrix, and judging a quasi-bond breakage condition according to the initial node displacement vector u^{trial};
step S5: carrying out iteration under current load, and updating the overall stiffness matrix K̅ of the target structure body, K̅=K̅^{cur}+ΔK̅, wherein K̅^{cur} is an overall stiffness matrix of the target structure body before updating, which is namely a system stiffness matrix after previous iteration; and ΔK̅ is a variable quantity of the overall stiffness matrix of the target structure body; and
calculating a convergence index after each iteration, and if the convergence index is less than a given error tolerance value, stopping the iteration, and entering step S6; and if the convergence index is greater than or equal to the given error tolerance value, continuously carrying out iteration;
step S6: calculating an actual node displacement u=K̅⁻¹F after updating the overall stiffness matrix of the target structure body and an equivalent damage parameter d_{I}, at each node, and outputting cloud charts of a displacement field and an equivalent damage field;
step S7: judging whether the load is applied completely, and if the load is not applied completely, returning to the step S3 to calculate a next load; and if the load is applied completely, ending the calculation; and
Step S8: carrying out grid sparsification on a continuous region and grid densification on a potential crack region to prevent damage and breakage of materials and structures based on the results of solid structure deformation and damage analysis method based on a quasi-bond finite element method through improving an assembly speed of the whole system stiffness matrix, using the finite element algorithm to naturally replace a continuous region and only using the quasi-bond method to calculate a potential crack region by utilizing a characteristic that the quasi-bond method and the finite element method both use a standard finite element grid for discretization.

The Chinese patent application, application number: 2023116403586, titled: structural deformation and damage analysis method based on inter-force bond finite element method, is the applicant's priority patent application, and the present invention is developed on the basis of this patent application. In view of the shortcomings of the priority patent application, the present invention improves an assembly speed of the whole system stiffness matrix, uses the finite element algorithm to naturally replace a continuous region and only uses the quasi-bond method to calculate a potential crack region by utilizing a characteristic that the quasi-bond method and the finite element method both use a standard finite element grid for discretization, and carries out grid sparsification on the continuous region and grid densification on the potential crack region, so as to optimize invalid calculation, and greatly improve the calculation efficiency under the same number of grids. Specific improvements are as follows.

Further, in the step S3, for a two-dimensional structure body, calculation steps of the quasi-bond region stiffness matrix K̅_{QBM}, of the target structure body Ω are as follows:
A1: acquiring a quasi-bond, wherein the grid of the traditional finite element method generated by subdividing the target structure body Ω subjected to distribution is a three-node triangular element; e_{I} elements Ω_{I}ⁱ connected with any node I are determined, i=1, 2, . . . , e_{I}, a cluster of rays with a number of N_{I} starting from an x axis are generated at any node I at equal angles, the rays are quasi-bonds, one of the quasi-bonds intersects with a line segment formed by a node J and a node K at a point p_{I}^{i,j}, a position vector of the point p_{I}^{i,j} is x_{I}^{i,j}, a position vector of the node I is x_{I}, a j^{th} quasi-bond ξ_{I}^{i,j}=x_{I}^{i,j}−x_{I} in an i^{th} element at the node I is obtained, and a total number of quasi-bonds at the node I is N_{I}; wherein, an included angle between any two adjacent quasi-bonds is Δθ, a number of quasi-bonds in the element Ω_{I}ⁱ is N_{I}ⁱ, ·_{I}^{i,j} represents a certain value of the j^{th} quasi-bond in the i^{th} element connected with the node I, and a quasi-bond intersecting with a prefabricated fracture is a failed quasi-bond;
A2: calculating a bond force, wherein the bond force f_{I}^{i,j} is calculated according to the following formula:

$${f}_{I}^{i , j} = {D}_{I}^{i , j} {η}_{I}^{i , j} ;$$

$${D}_{I}^{i , j} = \frac{c μ ( ξ , t )}{{‖ ξ ‖}^{4}} [ \begin{matrix}{ξ}_{x}^{2} & {ξ}_{x} {ξ}_{y} \\ {ξ}_{y} {ξ}_{x} & {ξ}_{y}^{2}\end{matrix} ] ;$$

in order to simplify expression, ξ is used in the formula to refer to ξ_{I}^{i,j}, ξₓ and ξ_{y} are components of the quasi-bond ξ_{I}^{i,j} in x and y directions, η_{I}^{i,j} is a relative deformation vector of the quasi-bond, η_{I}^{i,j} is expressed by a strain ε_{I}ⁱ of an element where the quasi-bond ξ_{I}^{i,j} is located, η_{I}^{i,j}=ε_{I}ⁱ·ξ_{I}^{i,j}, D_{I}^{i,j} is a quasi-bond stiffness matrix, μ(ξ, t) is a breakage weight function of the quasi-bond ξ_{I}^{i,j} in a t^{th} iteration, and c is a quasi-bond stiffness; and
A3: calculating the quasi-bond region stiffness matrix, wherein a node force resultant force of the node I is composed of a bond force resultant force q_{I} and a reaction force resultant force brought to the node I when bond forces of quasi-bonds at other nodes are calculated,

$${q}_{I} = {\sum }_{i = 1}^{{e}_{I}} {\sum }_{j = 1}^{{N}_{I}^{i}} {f}_{I}^{i , j} {A}^{i} h / {N}^{i} ,$$

and accordingly, a calculation formula of the quasi-bond region system stiffness matrix K̅_{QBM} of the target structure body is as follows:

$${\overline{K}}_{QBM} = {\sum }_{I = 1}^{0} {K}_{I} ;$$

$${K}_{I} = {\sum }_{i = 1}^{{e}_{I}} {\sum }_{j = 1}^{{N}_{I}^{i}} {G}_{i}^{T} {Q}_{I}^{i , j} {G}_{i} ,$$

$${Q}_{I}^{i , j} = {W}_{I} [ \begin{matrix}- D & {λ}_{K} D & {λ}_{J} D \\ {λ}_{K} D & - {λ}_{K}^{2} D & - {λ}_{K} {λ}_{J} D \\ {λ}_{J} D & - {λ}_{J} {λ}_{K} D & - {λ}_{J}^{2} D\end{matrix} ] ;$$

$${W}_{I} = {A}^{i} h / {N}^{i} ;$$

wherein, e_{I}, represents a number of quasi-bond elements connected with the node I, Nⁱ is a total number of quasi-bonds in the i^{th} element, N_{I}ⁱ represents a number of quasi-bonds in each element connected with the node I, Aⁱ is an area of the i^{th} element, h is a model thickness, o represents a number of nodes in the quasi-bond region in the target structure body, Gᵢ is a node freedom degree transformation matrix of the i^{th} element, ·^{T} represents matrix transposition, and Q_{I}^{i,j}, represents an element stiffness matrix under a combined action of a bond force and a bond force reaction force at the node I; for the two-dimensional structure body, Nⁱ≈π/Δθ; W_{I} is a quasi-bond volume differential element at the node I; and in order to simplify expression, elements in the matrix are λ_{K}=λ_{K}^{i,j}, λ_{J}=λ_{J}^{i,j} and D=D_{I}^{i,j}.

In further optimization, according to assumption of small deformation, a relative deformation vector of any quasi-bond ξ_{I}^{i,j} is expressed as η_{I}^{i,j}=ε_{I}ⁱξ_{I}^{i,j}, wherein ε_{I}ⁱ represents an element strain of the i^{th} element connected with the node I; and in order to simplify calculation, the element strain is calculated by using an element node displacement column vector, e_{I}ⁱ=B_{I}ⁱU_{I}ⁱ, and a matrix calculation method of a quasi-bond force density f_{I}^{i,j} is updated as:

$${f}_{I}^{i , j} = {D}_{I}^{i , j} {B}_{I}^{i} {U}_{I}^{i} ;$$

$${X}_{I}^{i , j} = [ \begin{matrix}{ξ}_{x} & 0 & \frac{1}{2} {ξ}_{y} \\ 0 & {ξ}_{y} & \frac{1}{2} {ξ}_{x}\end{matrix} ] ;$$

$${U}_{I}^{i} = {[ {u}_{1}^{x} {u}_{1}^{y} {u}_{2}^{x} {u}_{2}^{y} {u}_{3}^{x} {u}_{3}^{y} ]}^{T} ;$$

$${B}_{i} = [ \begin{matrix}\frac{\partial {N}_{1}}{\partial x} & 0 & \frac{\partial {N}_{2}}{\partial x} & 0 & \frac{\partial {N}_{3}}{\partial x} & 0 \\ 0 & \frac{\partial {N}_{1}}{\partial y} & 0 & \frac{\partial {N}_{2}}{\partial y} & 0 & \frac{\partial {N}_{3}}{\partial y} \\ \frac{\partial {N}_{1}}{\partial y} & \frac{\partial {N}_{1}}{\partial x} & \frac{\partial {N}_{2}}{\partial y} & \frac{\partial {N}_{2}}{\partial x} & \frac{\partial {N}_{3}}{\partial y} & \frac{\partial {N}_{3}}{\partial x}\end{matrix} ] ;$$

wherein, D_{I}^{i,j} is a bond stiffness matrix of the quasi-bond ε_{I}^{i,j}, B_{I}ⁱ is a shape function gradient matrix of the i^{th} element connected with the node I, x_{I}^{i,j} is a relative position transformation matrix of the quasi-bond ξ_{I}^{i,j}, and u_{I}ⁱ is a node displacement column vector of the i^{th} element; and in order to simplify expression, ξₓ and ξ_{y} in the matrix are components of the quasi-bond ξ_{I}^{i,j} in x and y directions, uₐ^{x} and uₐ^{y} represent components of a node displacement of the i^{th} element in x and y directions, and Nₐ is a shape function of the i^{th} element at each node, a=1, 2, 3.

In further optimization, in the step S3, for a three-dimensional structure body, calculation steps of the quasi-bond region stiffness matrix K̅_{QBM} are as follows:
B1: acquiring a quasi-bond, wherein the grid of the traditional finite element method generated by subdividing the target structure body subjected to distribution is a four-node tetrahedral element; e_{I} elements Ω_{I}ⁱ connected with any node I are determined, i=1, 2, . . . , e_{I}, cluster of rays with a number of N_{I} starting from an x axis are generated at any node I at equal angles, the rays are quasi-bonds, one of the quasi-bonds intersects with a plane formed by a node J, a node K and a node L at a point p_{I}^{i,j}, a position vector of the point p_{I}^{i,j} is x_{I}^{i,j}, a position vector of the node I is x_{I}, a j^{th} quasi-bond ξ_{I}^{i,j}=x_{I}^{i,j}−x_{I} in an i^{th} element at the node I is obtained, and a total number of quasi-bonds at the node I is N_{I}; wherein, a stereoscopic included angle between any two adjacent quasi-bonds is Δω, a number of quasi-bonds in the element Ω_{I}ⁱ is N_{I}ⁱ, ·_{I}^{i,j} represents a certain value of the j^{th} quasi-bond in the i^{th} element connected with the node I, and a quasi-bond intersecting with a prefabricated fracture is a failed quasi-bond;
B2: calculating a bond force, wherein the bond force f_{I}^{i,j} is calculated according to the following formula:

$${f}_{I}^{i , j} = {D}_{I}^{i , j} {η}_{I}^{i , j} ;$$

$${D}_{I}^{i , j} = \frac{c μ ( ξ , t )}{{‖ ξ ‖}^{4}} [ \begin{matrix}{ξ}_{x}^{2} & {ξ}_{x} {ξ}_{y} & {ξ}_{x} {ξ}_{z} \\ {ξ}_{y} {ξ}_{x} & {ξ}_{y}^{2} & {ξ}_{y} {ξ}_{z} \\ {ξ}_{z} {ξ}_{x} & {ξ}_{z} {ξ}_{y} & {ξ}_{z}^{2}\end{matrix} ] ;$$

in order to simplify expression, ξ is used in the formula to refer to ξ_{I}^{i,j}, ξₓ, ξ_{y} and ξ_{z} are components of the quasi-bond ξ_{I}^{i,j} in x, y and z directions, η_{I}^{i,j} is a relative deformation vector of the quasi-bond, η_{I}^{i,j} is expressed by a strain ε_{I}ⁱ of an element where the quasi-bond ξ_{I}^{i,j} is located, η_{I}^{i,j}=ε_{I}ⁱ·ξ_{I}^{i,j}, D_{I}^{i,j} is a quasi-bond stiffness matrix, μ(ξ, t) is a breakage weight function of the quasi-bond ξ_{I}^{i,j} in a t^{th} iteration, and c is a quasi-bond stiffness; and
B3: calculating the quasi-bond region stiffness matrix, wherein a node force resultant force of the node I is composed of a bond force resultant force q_{I} and a reaction force resultant force brought to the node I when bond forces of quasi-bonds at other nodes are calculated,

$$q = {\sum }_{i = 1}^{{e}_{I}} {\sum }_{{j = 1}^{}}^{{N}_{\text{?}}^{\text{?}}} {f}_{I}^{i , j} {V}^{i} / {N}^{i} ,$$

$$\text{?} \text{indicates text missing or illegible when filed}$$

and accordingly, a calculation formula of the quasi-bond region stiffness matrix K̅_{QBM} of the target structure body is as follows:

$${\overline{K}}_{QBM} = {\sum }_{I = 1}^{0} {\overline{K}}_{I} ;$$

$${\overline{K}}_{I} = {\sum }_{i = 1}^{{e}_{I}} {\sum }_{j = 1}^{{N}_{I}^{i}} {G}_{i}^{T} {Q}_{I}^{i , j} {G}_{j} ;$$

$${Q}_{I}^{i , j} = {W}_{I} [ \begin{matrix}- D & {s}_{J} D & {s}_{K} D & {s}_{L} D \\ {s}_{J} D & - {s}_{J}^{2} D & - {s}_{J} {s}_{K} D & - {s}_{J} {s}_{L} D \\ {s}_{K} D & - {s}_{j} {s}_{K} D & - {s}_{K}^{2} D & - {s}_{K} {s}_{L} D \\ {s}_{L} D & - {s}_{J} {s}_{K} D & - {s}_{K} {s}_{L} D & - {s}_{L}^{2} D\end{matrix} ] ;$$

$${W}_{I} = {V}^{i} / {N}^{i} ;$$

wherein, e_{I} represents a number of quasi-bond elements connected with the node I, Nⁱ is a total number of quasi-bonds in the i^{th} element, N_{I}ⁱ represents a number of quasi-bonds in each element connected with the node I, Vⁱ is a volume of the i^{th} element, o represents a number of nodes in the quasi-bond region in the target structure body, Gᵢ is a node freedom degree transformation matrix of the i^{th} element, ·^{T} represents matrix transposition, and Q_{I}^{i,j} represents an element stiffness matrix under a combined action of a bond force and a bond force reaction force at the node I; in the three-dimensional structure body,

$${N}^{i} \approx {\sum }_{g = 1}^{4} {ω}_{i , g} / Δω ; {ω}_{i , g}$$

is a stereoscopic included angle of a g^{th} node in the i^{th} element, and W_{I} is a quasi-bond volume differential element at the node I; and in order to simplify expression, elements in the matrix are S_{K}=S_{K}^{i,j}, S_{J}=S_{J}^{i,j}, s_{L}=s_{L}^{i,j} and D=D_{I}^{i,j}.

In further optimization, in the step B2, according to assumption of small deformation, a relative deformation vector η_{I}^{i,j} of any quasi-bond ξ_{I}^{i,j} is expressed as η_{I}^{i,j}=ε_{I}ⁱξ_{I}^{i,j}, wherein ε_{I}ⁱ represents an element strain of the i^{th} element connected with the node I; and in order to simplify calculation, the element strain is calculated by using an element node displacement column vector, ε_{I}ⁱ=B_{I}ⁱU_{I}ⁱ, and a matrix calculation method of a quasi-bond force density f_{I}^{i,j} is updated as:

$${f}_{I}^{i , j} = {D}_{I}^{i , j} {X}_{I}^{i , j} {B}_{I}^{i} {U}_{I}^{i} ;$$

$${X}_{I}^{i , j} = [ \begin{matrix}{ξ}_{x} & 0 & 0 & 0 & \frac{1}{2} {ξ}_{z} & \frac{1}{2} {ξ}_{y} \\ 0 & {ξ}_{y} & 0 & \frac{1}{2} {ξ}_{z} & 0 & \frac{1}{2} {ξ}_{x} \\ 0 & 0 & {ξ}_{z} & \frac{1}{2} {ξ}_{y} & \frac{1}{2} {ξ}_{x} & 0\end{matrix} ] ;$$

$${U}_{I}^{i} = {[ {u}_{1}^{x} {u}_{1}^{y} {u}_{1}^{z} {u}_{2}^{x} {u}_{2}^{y} {u}_{2}^{z} {u}_{3}^{x} {u}_{3}^{y} {u}_{3}^{z} {u}_{4}^{x} {u}_{4}^{y} {u}_{4}^{z} ]}^{T} ;$$

$${B}_{i} = [ \begin{matrix}\frac{\partial {N}_{1}}{\partial x} & 0 & 0 & \frac{\partial {N}_{2}}{\partial x} & 0 & 0 & \frac{\partial {N}_{3}}{\partial x} & 0 & 0 & \frac{\partial {N}_{4}}{\partial x} & 0 & 0 \\ 0 & \frac{\partial {N}_{1}}{\partial y} & 0 & 0 & \frac{\partial {N}_{2}}{\partial y} & 0 & 0 & \frac{\partial {N}_{3}}{\partial y} & 0 & 0 & \frac{\partial {N}_{4}}{\partial y} & 0 \\ 0 & 0 & \frac{\partial {N}_{1}}{\partial z} & 0 & 0 & \frac{\partial {N}_{2}}{\partial z} & 0 & 0 & \frac{\partial {N}_{3}}{\partial z} & 0 & 0 & \frac{\partial {N}_{4}}{\partial z} \\ 0 & \frac{\partial {N}_{1}}{\partial z} & \frac{\partial {N}_{1}}{\partial y} & 0 & \frac{\partial {N}_{2}}{\partial z} & \frac{\partial {N}_{2}}{\partial y} & 0 & \frac{\partial {N}_{3}}{\partial z} & \frac{\partial {N}_{3}}{\partial y} & 0 & \frac{\partial {N}_{4}}{\partial z} & \frac{\partial {N}_{4}}{\partial y} \\ \frac{\partial {N}_{1}}{\partial z} & 0 & \frac{\partial {N}_{1}}{\partial x} & \frac{\partial {N}_{2}}{\partial z} & 0 & \frac{\partial {N}_{2}}{\partial x} & \frac{\partial {N}_{3}}{\partial z} & 0 & \frac{\partial {N}_{3}}{\partial x} & \frac{\partial {N}_{2}}{\partial z} & 0 & \frac{\partial {N}_{2}}{\partial x} \\ \frac{\partial {N}_{1}}{\partial y} & \frac{\partial {N}_{1}}{\partial x} & 0 & \frac{\partial {N}_{2}}{\partial y} & \frac{\partial {N}_{2}}{\partial x} & 0 & \frac{\partial {N}_{3}}{\partial y} & \frac{\partial {N}_{3}}{\partial x} & 0 & \frac{\partial {N}_{4}}{\partial y} & \frac{\partial {N}_{4}}{\partial x} & 0\end{matrix} ] ;$$

wherein, D_{I}^{i,j} is a bond stiffness matrix of the quasi-bond ξ_{I}^{i,j}, B_{I}ⁱ is a shape function gradient matrix of the i^{th} element connected with the node I, x_{I}^{i,j}, is a relative position transformation matrix of the quasi-bond ξ_{I}^{i,j}, and u_{I}ⁱ is a node displacement column vector of the i^{th} element; and in order to simplify expression, ξₓ, ξ_{y} and ξ_{z} in the matrix are components of the quasi-bond ξ_{I}^{i,j} in x, y and z directions, uₐ^{x}, uₐ^{y} and uₐ^{z} respectively represent components of a node displacement of the i^{th} element in x, y and z directions, and Nₐ is a shape function of the i^{th} element at each node, a=1, 2, 3, 4.

In further optimization, in the step S3, calculation steps of the finite element region system stiffness matrix K̅_{FEM} are as follows:

$${\overline{K}}_{FEM} = - {\sum }_{i = 1}^{{m}_{F}} {G}_{i}^{T} {Re}^{j} {G}_{i} ;$$

$${Re}^{j} = {\int }_{{Ω}_{\text{?}}} {B}_{i}^{T} C {B}_{j} d Ω ;$$

$$\text{?} \text{indicates text missing or illegible when filed}$$

wherein, m_{F} is a number of elements in a finite element region Ω_{fEM}, Gᵢ is a node freedom degree transformation matrix of the i^{th} element Ωᵢ, in the finite element region Ω_{fEM}, which satisfies u=GᵢUᵢ, u is an overall node displacement vector of the target structure body, and uᵢ is a node displacement vector of the i^{th} element; and Reⁱ is an element stiffness matrix of the i^{th} element Ωᵢ, Bᵢ is a shape function gradient matrix of the i^{th} element, and C is a finite element elasticity matrix.

In further optimization, in the step S4, calculation steps of a force matrix F of the target structure body are as follows: an external load of the force matrix F of the target structure body is distributed to the node, so as to obtain that contributions of the quasi-bond region and the finite element region to the force matrix F of the target structure body are the same, and calculation methods are the same, which are both as follows:

$$F = {\sum }_{i = 1}^{m} {G}_{i}^{T} {F}_{i} ;$$

$${F}_{i} = {\int }_{{Ω}_{\text{?}}} {N}_{i}^{T} bd Ω ;$$

$${N}_{i} = [ \begin{matrix}{N}_{1} & 0 & 0 & … & {N}_{dim} & 0 & 0 \\ 0 & ⋱ & 0 & … & 0 & ⋱ & 0 \\ 0 & 0 & {N}_{1} & … & 0 & 0 & {N}_{dim}\end{matrix} ] ;$$

$$\text{?} \text{indicates text missing or illegible when filed}$$

wherein, m is a total number of elements of the target structure body; Gᵢ is the node freedom degree transformation matrix of the i^{th} element; Fᵢ is an element load vector of the i^{th} element Ωᵢ; Nᵢ is an element shape function matrix of the i^{th} element, Nₐ is the shape function at the node of the i^{th} element, and dim is a problem dimension, a=1, 2, 3 . . . , dim; and b is an external load vector of the node of the i^{th} element.

In further optimization, in the step S5, the convergence index is equal to ∥F^{t}−F^{t-1}∥/∥F^{t}∥, wherein, F^{t} represents a force matrix of the target structure body obtained in the step S3 in a t^{th} iteration, and F^{t-1} represents a force matrix of the target structure body obtained in the step S3 in a (t−1)^{t}h iteration; and
if ∥F^{t}−F^{t-1}∥/∥F^{t}∥<φ is satisfied, the force matrix is converged; and if ∥F^{t}−F^{t-1}∥/∥F^{t}∥<φ is not satisfied, the force matrix is not converged, wherein (p is a given error tolerance value.

In further optimization, in the step S5, calculation steps of the variable quantity ΔK̅ of the overall stiffness matrix of the target structure body are as follows:
the structure body is set as an elastic material, the initial node displacement vector u^{trial} is calculated, and then elongations I_{I}^{i,j} of all quasi-bonds are calculated, I_{I}^{i,j}=∥ξ_{I}^{i,j}+η_{I}^{i,j}∥/∥ξ_{I}^{i,j}∥, wherein η_{I}^{i,j} is a relative deformation vector of the quasi-bond ξ_{I}^{i,j}, and ∥g∥ represents a module length of the calculated vector; and
an elongation of a broken quasi-bond is set as 0, then the elongations of all quasi-bonds are sorted from large to small to form a sequence Y, the first M quasi-bonds in the Y are taken for breakage judgment, a sequence of newly added broken quasi-bonds after each iteration is recorded as Y_{c}, if a number of elements in the Y_{c} is 0, ΔK̅ is a zero matrix, and if the number of elements in the Y_{c} is not 0, the quasi-bond breakage weight function μ(ξ, t) in the Y_{c} is set as 0, and a variable quantity ΔK̅ of the overall stiffness matrix is calculated:

$$Δ \overline{K} = - {\sum }_{j ∈ {Y}_{c}} {G}_{j}^{T} {Q}^{j} {G}_{j} ;$$

wherein, Y_{c} is the sequence of the newly added broken quasi-bonds, Gⱼ is a node freedom degree transformation matrix corresponding to the j^{th} quasi-bond in the Y_{c}, and Q^{j} is a bond element stiffness matrix of the j^{th} quasi-bond in the Y_{c}.

In further optimization, a calculation method of a breakage weight function μ(ξ, t) of the quasi-bond ξ_{I}^{i,j} in the t^{th} iteration is:

$$μ ( ξ , t ) = \{ \begin{matrix}1 , & l < {l}_{c} \\ 0 , & l \geq {l}_{c}\end{matrix} ;$$

wherein, I is an elongation of the quasi-bond, and I_{c} is a given critical elongation;
a strain sampling scope is constructed for any node, the elongation I of the quasi-bond is calculated by using a smoothed strain ε̅_{I}, and calculation steps are as follows:

$$l = n \cdot {\overline{ε}}_{l} \cdot n ;$$

$$[ \begin{matrix}{\overline{ε}}_{l} \\ r\end{matrix} ] = {T}_{l} {U}_{l} ;$$

$${T}_{l} = {( {X}_{l}^{T} {X}_{l} )}^{- 1} {X}_{l}^{T} ;$$

$${X}_{l} = [ \begin{matrix}{x}_{1}^{1} & {x}_{2}^{1} & {x}_{3}^{1} & 1 \\ {x}_{1}^{2} & {x}_{2}^{2} & {x}_{3}^{2} & 1 \\ M & M & M & M \\ {x}_{1}^{v} & {x}_{2}^{v} & {x}_{3}^{v} & 1\end{matrix} ] ;$$

$${U}_{l} = [ \begin{matrix}{u}_{1}^{1} & {u}_{2}^{1} & {u}_{3}^{1} \\ {u}_{1}^{2} & {u}_{2}^{2} & {u}_{3}^{2} \\ M & M & M \\ {u}_{1}^{v} & {u}_{2}^{v} & {u}_{3}^{v}\end{matrix} ] ;$$

wherein, n is a direction vector n=ξ_{I}^{i,j}/∥ξ_{I}^{i,j}∥ of the quasi-bond ξ_{I}^{i,j}, T_{I} is a smoothed strain transformation matrix, U_{I} is a matrix formed by displacements of all nodes in the strain sampling scope at the node I, and X_{I} is a position matrix of all nodes in the strain sampling scope at the node I; and in order to simplify expression, in the matrix, xₐ^{v} represents an a^{th} component of a position vector of a v^{th} node in the sampling scope, and uₐ^{v} represents an a^{th} component of a displacement vector of the v^{th} node in the sampling scope, a=1, 2, 3.

Compared with the prior art, the present invention has the following beneficial effects.

The solid structure deformation and damage analysis method based on the quasi-bond finite element method according to the present invention inherits the advantage of small bandwidth of system stiffness matrix in the quasi-bond method, provides a new numerical calculation technology—quasi-bond finite element method by using the ability of the quasi-bond method to simulate damage and failure, and only carries out quasi-bond discretization in a region of interest of breakage, so that the calculation efficiency of this method is equivalent to that of a finite element method, and meanwhile, the calculation efficiency of this method far exceeds that of a quasi-bond method during damage iteration, thereby popularizing and applying model damage calculation to numerical simulation of large-scale projects such as slopes and tunnels.

### BRIEF DESCRIPTION OF THE DRAWINGS

FIG. 1 is a schematic diagram of quasi-bond discretization and coupling in a solid structure deformation and damage analysis method based on a quasi-bond finite element method according to the present invention;

FIG. 2a is a schematic diagram of a number of quasi-bonds in an element that shows all quasi-bonds in the element;

FIG. 2b is a schematic diagram of a number of quasi-bonds in an element that shows a quasi-bond at a node I;

FIG. 3 is a schematic diagram of a smoothed strain sampling scope;

FIG. 4a is a schematic diagram of geometric dimensions and boundary conditions for simulating deformation of a lossless continuous plate by stretching and shearing ways in Embodiment 1 that is a schematic diagram corresponding to the stretching way;

FIG. 4b is a schematic diagram of geometric dimensions and boundary conditions for simulating deformation of a lossless continuous plate by stretching and shearing ways in Embodiment 1 that is a schematic diagram corresponding to the shearing way;

FIG. 5 is an image of a calculation grid in Embodiment 1;

FIG. 6 is a flow chart of solution of an implicit expression of a continuum in Embodiment 1;

FIG. 7a is a calculation result diagram of a displacement field under the stretching way in Embodiment 1 is a calculation result diagram of the displacement field in an x direction;

FIG. 7b is a calculation result diagram of a displacement field under the stretching way in Embodiment 1 that is a calculation result diagram of the displacement field in a y direction;

FIG. 8 is a comparison diagram of calculation results of a displacement in the x direction at a coupling boundary under the stretching way by different methods in Embodiment 1;

FIG. 9 is a comparison diagram of calculation results of a displacement in they direction at the coupling boundary under the stretching way by different methods in Embodiment 1;

FIG. 10a is a calculation result diagram of a displacement field under the shearing way in Embodiment 1 that is a calculation result diagram of the displacement field in the x direction;

FIG. 10b is a calculation result diagram of a displacement field under the shearing way in Embodiment 1 that is a calculation result diagram of the displacement field in they direction;

FIG. 11 is a comparison diagram of calculation results of a displacement in the x direction at the coupling boundary under the shearing way by different methods in Embodiment 1;

FIG. 12 is a comparison diagram of calculation results of a displacement in they direction at the coupling boundary under the shearing way by different methods in Embodiment 1;

FIG. 13a is a schematic diagram of geometric dimensions and boundary conditions for simulating deformation of a sheet by stretching and shearing ways in Embodiment 2 that is a schematic diagram corresponding to the stretching way;

FIG. 13b is a schematic diagram of geometric dimensions and boundary conditions for simulating deformation of a sheet by stretching and shearing ways in Embodiment 2 that is a schematic diagram corresponding to the shearing way;

FIG. 14a is an image of a calculation grid in Embodiment 2 that is an image of a grid corresponding to the stretching way;

FIG. 14b is an image of a calculation grid in Embodiment 2 that is an image of a grid corresponding to the shearing way;

FIG. 15 is a flow chart of structural damage analysis under multi-stage loading;

FIG. 16a is a calculation result diagram of a damage under the stretching way in Embodiment 2 that shows a calculation result when u_{y}=2.25×10⁻³ mm;

FIG. 16b is a calculation result diagram of a damage under the stretching way in Embodiment 2 that shows a calculation result when u_{y}=2.5×10⁻³ mm;

FIG. 17a is a calculation result diagram of a displacement field in an x direction under the stretching way in Embodiment 2 that shows a calculation result when u_{y}=2.25×10⁻³ mm;

FIG. 17b is a calculation result diagram of a displacement field in an x direction under the stretching way in Embodiment 2 that shows a calculation result when u_{y}=2.5×10⁻³ mm;

FIG. 18a is a calculation result diagram of a displacement field in a y direction under the stretching way in Embodiment 2 that shows a calculation result when u_{y}=2.25×10⁻³ mm;

FIG. 18b is a calculation result diagram of a displacement field in ay direction under the stretching way in Embodiment 2 that shows a calculation result when u_{y}=2.5×10⁻³ mm;

FIG. 19a is a calculation result diagram of a damage under the shearing way in Embodiment 2 that shows a calculation result when uₓ=4.2×10⁻³ mm;

FIG. 19b is a calculation result diagram of a damage under the shearing way in Embodiment 2 that shows a calculation result when uₓ=6.0×10⁻³ mm;

FIG. 20a is a calculation result diagram of a displacement field in the x direction under the shearing way in Embodiment 2 that shows a calculation result when uₓ=4.2×10⁻³ mm;

FIG. 20b is a calculation result diagram of a displacement field in the x direction under the shearing way in Embodiment 2 that shows a calculation result when uₓ=6.0×10⁻³ mm;

FIG. 21a is a calculation result diagram of a displacement field in they direction under the shearing way in Embodiment 2 that shows a calculation result when uₓ=4.2×10⁻³ mm;

FIG. 21b is a calculation result diagram of a displacement field in they direction under the shearing way in Embodiment 2 that shows a calculation result when uₓ=6.0×10⁻³ mm;

FIG. 22 is a diagram of geometric dimension and boundary condition for simulating deformation of a sheet by a stretching way in Embodiment 3;

FIG. 23 is an image of a calculation grid in Embodiment 3;

FIG. 24a is a cloud chart of an equivalent damage of a target structure body in Embodiment 3 that is a cloud chart of an equivalent damage under deformation of u_{y}=3.5×10⁻¹ mm;

FIG. 24b is a cloud chart of an equivalent damage of a target structure body in Embodiment 3 that is a cloud chart of an equivalent damage under deformation of u_{y}=6.44×10⁻¹ mm;

FIG. 25a is a calculation result diagram of a displacement field of the target structure body in an x direction in Embodiment 3; wherein (a) shows a displacement under deformation of uₓ=3.5×10⁻¹ mm, and (b) shows a displacement in the x direction under deformation of uₓ=6.44×10⁻¹ mm;

FIG. 25b is a calculation result diagram of a displacement field of the target structure body in an x direction in Embodiment 3 that shows a displacement in the x direction under deformation of uₓ=6.44×10⁻¹ mm;

FIG. 26a is a calculation result diagram of a displacement field of the target structure body in a y direction in Embodiment 3 that shows a displacement under deformation of u_{y}=3.5×10⁻¹ mm;

FIG. 26b is a calculation result diagram of a displacement field of the target structure body in a y direction in Embodiment 3 that shows a displacement in the y direction under deformation of u_{y}=6.44×10⁻¹ mm;

FIG. 27 is a comparison diagram of assembly speeds of a whole stiffness matrix of the target structure body by a finite element method and a quasi-bond finite element method in Embodiment 3;

FIG. 28 is an image of geometric dimension, material division and calculation grid of the target structure body in Embodiment 4;

FIG. 29 is a calculation result diagram of a damage after crack penetration in a concrete beam in the target structure body and a comparison diagram of a physical object experiment in Embodiment 4; wherein (a) is a calculation result diagram of damages of the concrete beam at different angles, and (b) is a result diagram of the physical object experiment; and

FIG. 30 is a relationship diagram between a crack tip opening displacement (CM OD) of the concrete beam in the target structure body and a reaction force resultant force of a loading surface of a steel fixture in Embodiment 4.

### DETAILED DESCRIPTION

Specific implementing methods are given hereinafter with reference to specific calculating examples to further describe the present invention. It should be understood that the examples are only used for describing the present invention and are not intended to limit the scope of protection of the present invention.

A structure deformation and damage analysis method based on a quasi-bond finite element method comprising a non-transitory computer readable medium operable on a computer with memory for the solid structure deformation and damage analysis method based on a quasi-bond finite element method, and comprising program instructions for executing the following steps of:

In step S1, geometric modeling is carried out on a target structure body Ω, and distribution and subdivision is carried out on a model boundary to generate a grid of a traditional finite element method, so as to obtain several elements and nodes.

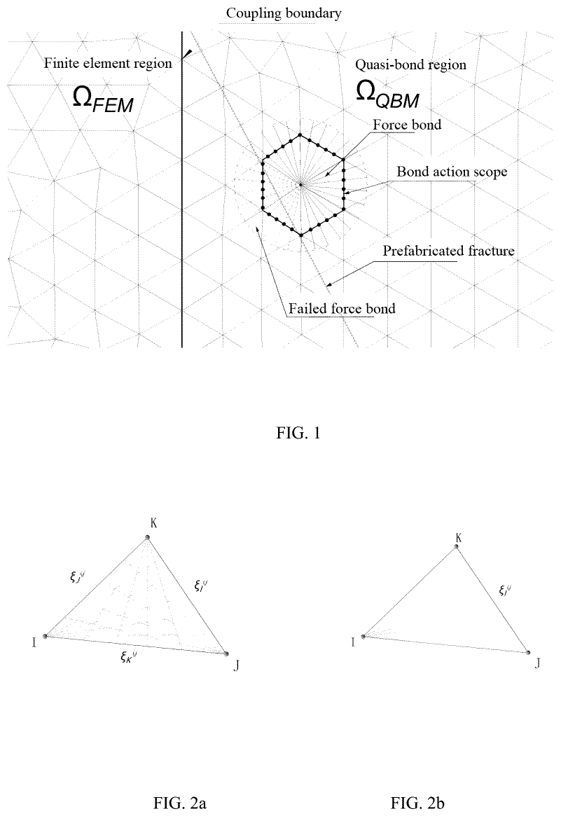

In step S2: a fracture 5 is preset on the target structure body Ω, and the target structure body Ω is divided into a finite element calculation region Ω_{FEM}1 and a quasi-bond calculation region Ω_{QBM}2, wherein a potential occurrence region of fracture 5 and crack is located in the quasi-bond calculation region 2, and there is a coupling boundary 3 between the finite element calculation region 1 and the quasi-bond calculation region, as shown in FIG. 1.

In step S3, a boundary condition is set for the target structure body Ω, an external load is applied, a force matrix F, a finite element region system stiffness matrix K̅_{FEM} and a quasi-bond region system stiffness matrix K̅_{QBM} of the target structure body under the load and boundary state are calculated, and an overall stiffness matrix K̅ of the target structure body is assembled, K̅=K̅_{FEM}+K̅_{QBM}.

For a two-dimensional structure body, calculation steps of the quasi-bond region stiffness matrix K̅_{QBM} of the target structure body Ω are as follows.

In A1, a quasi-bond is acquired, wherein, as shown in FIG. 2, the grid of the traditional finite element method generated by subdividing the target structure body Ω subjected to distribution is a three-node triangular element; e_{I} elements Ω_{I}ⁱ connected with any node I are determined, i=1, 2, . . . , e_{I}, a cluster of rays with a number of N_{I} starting from an x axis are generated at any node I at equal angles, the rays are as shown in FIG. 2(b), the rays are quasi-bonds 4, all quasi-bonds 4 form a quasi-bond action scope 7, one of the quasi-bonds intersects with a line segment formed by a node J and a node K at a point p_{I}^{i,j}, a position vector of the point p_{I}^{i,j} is x_{I}^{i,j}, a position vector of the node I is x_{I}, a j^{th} quasi-bond ξ_{I}^{i,j}=x_{I}^{i,j}−x_{I} in an i^{th} element at the node I is obtained, and a total number of quasi-bonds at the node I is N_{I}, as shown in FIG. 2(a). A n included angle between any two adjacent quasi-bonds is Δθ, a number of quasi-bonds in the element Ω_{I}ⁱ is N_{I}ⁱ, ·_{I}^{i,j} represents a certain value of the j^{th} quasi-bond in the i^{th} element connected with the node I, and a quasi-bond intersecting with a prefabricated fracture 5 is a failed quasi-bond 6.

In A2, a bond force is calculated, wherein the bond force f_{I}^{i,j} is calculated according to the following formula:

$${f}_{l}^{i , j} = {D}_{l}^{i , j} {η}_{l}^{i , j} ;$$

$${D}_{l}^{i , j} = \frac{c μ ( ξ , t )}{{‖ ξ ‖}^{4}} [ \begin{matrix}{ξ}_{x}^{2} & {ξ}_{x} {ξ}_{y} \\ {ξ}_{y} {ξ}_{x} & {ξ}_{y}^{2}\end{matrix} ] ;$$

in order to simplify expression, ξ is used in the formula to refer to ξ_{I}^{i,j}, ξₓ and ξ_{y} are components of the quasi-bond ξ_{I}^{i,j} in x and y directions, η_{I}^{i,j} is a relative deformation vector of the quasi-bond, η_{I}^{i,j} is expressed by a strain ε_{I}ⁱ of an element where the quasi-bond ξ_{I}^{i,j} is located, η_{I}^{i,j}=ε_{I}ⁱ·ξ_{I}^{i,j}, D_{I}^{i,j} is a quasi-bond stiffness matrix, μ(ξ, t) is a breakage weight function of the quasi-bond ξ_{I}^{i,j} in a t^{th} iteration, and c is a quasi-bond stiffness. For a plane stress problem, c=3E; and for a plane strain problem, c=16E/5, wherein E is a Young's modulus of the target structure body.

According to assumption of small deformation, a relative deformation vector of any quasi-bond ξ_{I}^{i,j} is expressed as η_{I}^{i,j}=ε_{I}ⁱξ_{I}^{i,j}, wherein ε_{I}ⁱ; represents an element strain of the i^{th} element connected with the node I; and in order to simplify calculation, the element strain is calculated by using an element node displacement column vector, ε_{I}ⁱ=B_{I}ⁱU_{I}ⁱ, and a matrix calculation method of a quasi-bond force density f_{I}^{i,j} is updated as:

$${f}_{l}^{i , j} = {D}_{l}^{i , j} {X}_{l}^{i , j} {B}_{l}^{i} {U}_{l}^{i} ;$$

$${X}_{l}^{i , j} = [ \begin{matrix}{ξ}_{x} & 0 & \frac{1}{2} {ξ}_{y} \\ 0 & {ξ}_{y} & \frac{1}{2} {ξ}_{x}\end{matrix} ] ;$$

$${U}_{l}^{i} = {[ \begin{matrix}{u}_{1}^{x} & {u}_{1}^{y} & {u}_{2}^{x} & {u}_{2}^{y} & {u}_{3}^{x} & {u}_{3}^{y}\end{matrix} ]}^{T} ;$$

$${B}_{i} = [ \begin{matrix}\frac{\partial {N}_{1}}{\partial x} & 0 & \frac{\partial {N}_{2}}{\partial x} & 0 & \frac{\partial {N}_{3}}{\partial x} & 0 \\ 0 & \frac{\partial {N}_{1}}{\partial y} & 0 & \frac{\partial {N}_{2}}{\partial y} & 0 & \frac{\partial {N}_{3}}{\partial y} \\ \frac{\partial {N}_{1}}{\partial y} & \frac{\partial {N}_{1}}{\partial x} & \frac{\partial {N}_{2}}{\partial y} & \frac{\partial {N}_{2}}{\partial x} & \frac{\partial {N}_{3}}{\partial y} & \frac{\partial {N}_{3}}{\partial x}\end{matrix} ] ;$$

wherein, D_{I}^{i,j} is a bond stiffness matrix of the quasi-bond ξ_{I}^{i,j}, B_{I}ⁱ is a shape function gradient matrix of the i^{th} element connected with the node I, x_{I}^{i,j} is a relative position transformation matrix of the quasi-bond ξ_{I}^{i,j} and u_{I}ⁱ is a node displacement column vector of the i^{th} element; and in order to simplify expression, ξₓ and ξ_{y} in the matrix are components of the quasi-bond ξ_{I}^{i,j} in x and y directions, uₐ^{x} and uₐ^{y} represent components of a node displacement of the i^{th} element in x and y directions, and Nₐ is a shape function of the i^{th} element at each node, a=1, 2, 3.

In A3, the quasi-bond region stiffness matrix is calculated, wherein a node force resultant force of the node I is composed of a bond force resultant force q_{I} and a reaction force resultant force brought to the node I when bond forces of quasi-bonds at other nodes are calculated,

$${q}_{l} = {\sum }_{i = 1}^{{e}_{l}} {\sum }_{j = 1}^{{N}_{l}^{i}} {f}_{l}^{i , j} {A}^{i} h / {N}^{i} ,$$

and accordingly, a calculation formula of the quasi-bond region system stiffness matrix K̅_{QBM} of the target structure body is as follows:

$${\overline{K}}_{QBM} = {\sum }_{l = 1}^{o} {K}_{l} ;$$

$${K}_{l} = {\sum }_{i = 1}^{{e}_{l}} {\sum }_{j = 1}^{{N}_{l}^{i}} {G}_{i}^{T} {Q}_{l}^{i , j} {G}_{i} ;$$

$${Q}_{l}^{i , j} = {W}_{l} [ \begin{matrix}- D & {λ}_{K} D & {λ}_{J} D \\ {λ}_{K} D & - {λ}_{K}^{2} D & - {λ}_{K} {λ}_{J} D \\ {λ}_{J} D & - {λ}_{J} {λ}_{K} D & - {λ}_{J}^{2} D\end{matrix} ] ;$$

$${W}_{l} = {A}^{i} h / {N}^{i} ;$$

wherein, e_{I}, represents a number of quasi-bond elements connected with the node I, Nⁱ is a total number of quasi-bonds in the i^{th} element, N_{I}ⁱ represents a number of quasi-bonds in each element connected with the node I, Aⁱ is an area of the i^{th} element, h is a model thickness, o represents a number of nodes in the quasi-bond region in the target structure body, Gᵢ is a node freedom degree transformation matrix of the i^{th} element, ·^{T} represents matrix transposition, and Q_{I}^{i,j} represents an element stiffness matrix under a combined action of a bond force and a bond force reaction force at the node I; for the two-dimensional structure body, Nᵢ≈π/Δθ; W_{I} is a quasi-bond volume differential element at the node I; and in order to simplify expression, elements in the matrix are λ_{K}=λ_{K}^{i,j}, λ_{K}=λ_{K}^{i,j} and D=D_{I}^{i,j}.

For a three-dimensional structure body, calculation steps of the quasi-bond region stiffness matrix K̅_{QBM} are as follows.

In B1, a quasi-bond is acquired, wherein the grid of the traditional finite element method generated by subdividing the target structure body subjected to distribution is a four-node tetrahedral element; e_{I} elements connected with any node I are determined, i=1, 2, . . . , e_{I}, a cluster of rays with a number of N_{I} starting from an x axis are generated at any node I at equal angles, the rays are quasi-bonds, one of the quasi-bonds intersects with a plane formed by a node J, a node K and a node L at a point p_{I}^{i,j}, a position vector of the point p_{I}^{i,j} is x_{I}^{i,j}, a position vector of the node I is x_{I}, a j^{th} quasi-bond ξ_{I}^{i,j}=x_{I}^{i,j}−x_{I} in an i^{th} element at the node I is obtained, and a total number of quasi-bonds at the node I is N_{I}; wherein, a stereoscopic included angle between any two adjacent quasi-bonds is Δω, a number of quasi-bonds in the element Ω_{I}ⁱ is N_{I}ⁱ, ·_{I}^{i,j} represents a certain value of the j^{th} quasi-bond in the i^{th} element connected with the node I, and a quasi-bond intersecting with a prefabricated fracture is a failed quasi-bond.

In B2, a bond force is calculated, wherein the bond force f_{I}^{i,j} is calculated according to the following formula:

$${f}_{l}^{i , j} = {D}_{l}^{i , j} {η}_{l}^{i , j} ;$$

$${D}_{l}^{i , j} = \frac{c μ ( ξ , t )}{{‖ ξ ‖}^{4}} [ \begin{matrix}{ξ}_{x}^{2} & {ξ}_{x} {ξ}_{y} & {ξ}_{x} {ξ}_{z} \\ {ξ}_{y} {ξ}_{x} & {ξ}_{y}^{2} & {ξ}_{y} {ξ}_{z} \\ {ξ}_{z} {ξ}_{x} & {ξ}_{z} {ξ}_{y} & {ξ}_{z}^{2}\end{matrix} ] ;$$

in order to simplify expression, ξ is used in the formula to refer to ξ_{I}^{i,j}, ξₓ, ξ_{y} and ξ_{z} are components of the quasi-bond ξ_{I}^{i,j} in x, y and z directions, η_{I}^{i,j} is a relative deformation vector of the quasi-bond, η_{I}^{i,j} is expressed by a strain ε_{I}ⁱ of an element where the quasi-bond ξ_{I}^{i,j} is located, η_{I}^{i,j}=ε_{I}ⁱ·ξ_{I}^{i,j}, D_{I}^{i,j} is a quasi-bond stiffness matrix, μ(ξ, t) is a breakage weight function of the quasi-bond ξ_{I}^{i,j} in a t^{th} iteration, and c is a quasi-bond stiffness, c=3E, wherein E is a Young's modulus of the target structure body.

According to assumption of small deformation, a relative deformation vector η_{I}^{i,j} of any quasi-bond ξ_{I}^{i,j} is expressed as η_{I}^{i,j}=ε_{I}ⁱξ_{I}^{i,j}, wherein ε_{I}ⁱ; represents an element strain of the i^{th} element connected with the node I; and in order to simplify calculation, the element strain is calculated by using an element node displacement column vector, ε_{I}ⁱ=B_{I}ⁱU_{I}ⁱ, and a matrix calculation method of a quasi-bond force density f_{I}^{i,j} is updated as:

$${f}_{l}^{i , j} = {D}_{l}^{i , j} {X}_{l}^{i , j} {B}_{l}^{i} {U}_{l}^{i} ;$$

$${X}_{l}^{i , j} = [ \begin{matrix}{ξ}_{x} & 0 & 0 & 0 & \frac{1}{2} {ξ}_{z} & \frac{1}{2} {ξ}_{y} \\ 0 & {ξ}_{y} & 0 & \frac{1}{2} {ξ}_{z} & 0 & \frac{1}{2} {ξ}_{x} \\ 0 & 0 & {ξ}_{z} & \frac{1}{2} {ξ}_{y} & \frac{1}{2} {ξ}_{x} & 0\end{matrix} ] ;$$

$${U}_{l}^{i} = {[ \begin{matrix}{u}_{1}^{x} & {u}_{1}^{y} & {u}_{1}^{z} & {u}_{2}^{x} & {u}_{2}^{y} & {u}_{2}^{z} & {u}_{3}^{x} & {u}_{3}^{y} & {u}_{3}^{z} & {u}_{4}^{x} & {u}_{4}^{y} & {u}_{4}^{z}\end{matrix} ]}^{T} ;$$

$${B}_{i} = [ \begin{matrix}\frac{\partial {N}_{1}}{\partial x} & 0 & 0 & \frac{\partial {N}_{2}}{\partial x} & 0 & 0 & \frac{\partial {N}_{3}}{\partial x} & 0 & 0 & \frac{\partial {N}_{4}}{\partial x} & 0 & 0 \\ 0 & \frac{\partial {N}_{1}}{\partial y} & 0 & 0 & \frac{\partial {N}_{2}}{\partial y} & 0 & 0 & \frac{\partial {N}_{3}}{\partial y} & 0 & 0 & \frac{\partial {N}_{4}}{\partial y} & 0 \\ 0 & 0 & \frac{\partial {N}_{1}}{\partial z} & 0 & 0 & \frac{\partial {N}_{2}}{\partial z} & 0 & 0 & \frac{\partial {N}_{3}}{\partial z} & 0 & 0 & \frac{\partial {N}_{4}}{\partial z} \\ 0 & \frac{\partial {N}_{1}}{\partial z} & \frac{\partial {N}_{1}}{\partial y} & 0 & \frac{\partial {N}_{2}}{\partial z} & \frac{\partial {N}_{2}}{\partial y} & 0 & \frac{\partial {N}_{3}}{\partial z} & \frac{\partial {N}_{3}}{\partial y} & 0 & \frac{\partial {N}_{4}}{\partial z} & \frac{\partial {N}_{4}}{\partial y} \\ \frac{\partial {N}_{1}}{\partial z} & 0 & \frac{\partial {N}_{1}}{\partial x} & \frac{\partial {N}_{2}}{\partial z} & 0 & \frac{\partial {N}_{2}}{\partial x} & \frac{\partial {N}_{3}}{\partial z} & 0 & \frac{\partial {N}_{3}}{\partial x} & \frac{\partial {N}_{4}}{\partial z} & 0 & \frac{\partial {N}_{4}}{\partial x} \\ \frac{\partial {N}_{1}}{\partial y} & \frac{\partial {N}_{1}}{\partial x} & 0 & \frac{\partial {N}_{2}}{\partial y} & \frac{\partial {N}_{2}}{\partial x} & 0 & \frac{\partial {N}_{3}}{\partial y} & \frac{\partial {N}_{3}}{\partial x} & 0 & \frac{\partial {N}_{4}}{\partial y} & \frac{\partial {N}_{4}}{\partial x} & 0\end{matrix} ] ;$$

wherein, D_{I}^{i,j} is a bond stiffness matrix of the quasi-bond ξ_{I}^{i,j}, B_{I}ⁱ is a shape function gradient matrix of the i^{th} element connected with the node I, x_{I}^{i,j} is a relative position transformation matrix of the quasi-bond ξ_{I}^{i,j}, and u_{I}ⁱ is a node displacement column vector of the i^{th} element; and in order to simplify expression, ξₓ, ξ_{y} and ξ_{z} in the matrix are components of the quasi-bond ξ_{I}^{i,j} in x, y and z directions, uₐ^{x}, uₐ^{y} and uₐ^{z} respectively represent components of a node displacement of the i^{th} element in x, y and z directions, and Nₐ is a shape function of the i^{th} element at each node, a=1, 2, 3, 4.

In B3, the quasi-bond region stiffness matrix is calculated, wherein a node force resultant force of the node I is composed of a bond force resultant force q_{I} and a reaction force resultant force brought to the node I when bond forces of quasi-bonds at other nodes are calculated,

$$q = {\sum }_{i = 1}^{{e}_{l}} {\sum }_{j = 1}^{{N}_{l}^{i}} {f}_{l}^{i , j} {V}^{i} / {N}^{i} ,$$

and a calculation formula of the quasi-bond region stiffness matrix K̅_{QBM} of the target structure body is as follows:

$${\overline{K}}_{QBM} = {\sum }_{l = 1}^{o} {\overline{K}}_{l} ;$$

$${\overline{K}}_{l} = {\sum }_{i = 1}^{{e}_{l}} {\sum }_{j = 1}^{{N}_{l}^{i}} {G}_{i}^{T} {Q}_{l}^{i , j} {G}_{i} ;$$

$${Q}_{l}^{i , j} = {W}_{l} [ \begin{matrix}- D & {S}_{J} D & {S}_{K} D & {S}_{L} D \\ {S}_{J} D & - {S}_{J}^{2} D & - {S}_{J} {S}_{K} D & - {S}_{J} {S}_{L} D \\ {S}_{K} D & - {S}_{J} {S}_{K} D & - {S}_{K}^{2} D & - {S}_{K} {S}_{L} D \\ {S}_{L} D & - {S}_{J} {S}_{K} D & - {S}_{K} {S}_{L} D & - {S}_{L}^{2} D\end{matrix} ] ;$$

$${W}_{l} = {V}^{i} / {N}^{i} ;$$

wherein, el represents a number of quasi-bond elements connected with the node I, Nⁱ is a total number of quasi-bonds in the i^{th} element, N_{I}ⁱ represents a number of quasi-bonds in each element connected with the node I, Vⁱ is a volume of the i^{th} element, o represents a number of nodes in the quasi-bond region in the target structure body, Gᵢ is a node freedom degree transformation matrix of the i^{th} element, ·^{T} represents matrix transposition, and Q_{I}^{i,j} represents an element stiffness matrix under a combined action of a bond force and a bond force reaction force at the node I; in the three-dimensional structure body,

$${N}^{i} \approx {\sum }_{g = 1}^{4} {ω}_{i , g} / Δω ; {ω}_{i , g}$$

is a stereoscopic included angle of a g^{th} node in the i^{th} element, and W_{I} is a quasi-bond volume differential element at the node I; and in order to simplify expression, elements in the matrix are S_{K}=S_{K}^{i,j}, S_{J}=S_{J}^{i,j}, s_{L}=s_{L}^{i,j} and D=D_{I}^{i,j}.

For the finite element region Ω_{fEM}, traditional linear elastic constitutive model and linear element method are used to generate the stiffness matrix, and a calculation method is as follows:

$${\overline{K}}_{FEM} = - {\sum }_{i = 1}^{{m}_{F}} {G}_{i}^{T} {Re}^{i} {G}_{i} ;$$

$${Re}^{i} = {\int }_{{Ω}_{i}} {B}_{i}^{T} {CB}_{i} d Ω ;$$

wherein, m_{F} is a number of elements in a finite element region Ω_{fEM}, Gᵢ is a node freedom degree transformation matrix of the i^{th} element Ωᵢ in the finite element region Ω_{fEM}, which satisfies u=Gᵢuᵢ, u is an overall node displacement vector of the target structure body, and uᵢ is a node displacement vector of the i^{th} element; and Reⁱ is an element stiffness matrix of the i^{th} element Ωᵢ, Bᵢ is a shape function gradient matrix of the i^{th} element, and C is a finite element elasticity matrix.

Calculation steps of a force matrix F of the target structure body are as follows: an external load of the force matrix F of the target structure body is distributed to the node, so as to obtain that contributions of the quasi-bond region and the finite element region to the force matrix F of the target structure body are the same, and calculation methods are the same, which are both as follows:

$$F = {\sum }_{m = 1}^{m} {G}_{i}^{T} {F}_{i} ;$$

$${F}_{i} = {\int }_{{Ω}_{i}} {N}_{i}^{T} bd Ω ;$$

$${N}_{i} = [ \begin{matrix}{N}_{1} & 0 & 0 & ⋯ & {N}_{dim} & 0 & 0 \\ 0 & ⋱ & 0 & ⋯ & 0 & ⋱ & 0 \\ 0 & 0 & {N}_{1} & ⋯ & 0 & 0 & {N}_{dim}\end{matrix} ] ;$$

wherein, m is a total number of elements of the target structure body; Gᵢ is the node freedom degree transformation matrix of the i^{th} element; Fᵢ is an element load vector of the i^{th} element Ωᵢ; Nᵢ is an element shape function matrix of the i^{th} element, Nₐ is the shape function at the node of the i^{th} element, and dim is a problem dimension, a=1, 2, 3 . . . , dim; and b is an external load vector of the node of the i^{th} element.

In step S4, the target structure body is set as an elastic material, there is no damage after applying the external load, an initial node displacement vector u^{trial} is calculated, wherein the u^{trial} is equal to multiplication of an initial overall stiffness matrix of the target structure body and an initial force matrix, and a quasi-bond breakage condition is judged according to the initial node displacement vector u^{trial}.

In step S5, iteration is carried out under current load, and the overall stiffness matrix K̅ of the target structure body is updated, K̅=K̅^{cur}+ΔK̅, wherein K̅^{cur} is an overall stiffness matrix of the target structure body before updating, which is namely a system stiffness matrix after previous iteration; and ΔK̅ is a variable quantity of the overall stiffness matrix of the target structure body.

A convergence index is calculated after each iteration, and if the convergence index is less than a given error tolerance value, the iteration stopped, and step S6 is implemented; and if the convergence index is greater than or equal to the given error tolerance value, iteration is continuously carried out.

The convergence index is equal to ∥F^{t}−F^{t-1}∥/∥F^{t}∥, wherein, F^{t} represents a force matrix of the target structure body obtained in the step S3 in a t^{th} iteration, and F^{t-1} represents a force matrix of the target structure body obtained in the step S3 in a (t−1)^{th} iteration.

The structure body is set as an elastic material, the initial node displacement vector u^{trial} is calculated, and then elongations I_{I}^{i,j} of all quasi-bonds are calculated, I_{I}^{i,j}=∥ξ_{I}^{i,j}+η_{I}^{i,j}∥/∥ξ_{I}^{i,j}∥, wherein η_{I}^{i,j} is a relative deformation vector of the quasi-bond ξ_{I}^{i,j}, and ∥g∥ represents a module length of the calculated vector.

An elongation of a broken quasi-bond is set as 0, then the elongations of all quasi-bonds are sorted from large to small to form a sequence Y, the first M quasi-bonds in the Y are taken for breakage judgment, a sequence of newly added broken quasi-bonds after each iteration is recorded as Y_{c}, if a number of elements in the Y_{c} is 0, ΔK̅ is a zero matrix, and if the number of elements in the Y_{c} is not 0, the quasi-bond breakage weight function μ(ξ, t) in the Y_{c} is set as 0, and a variable quantity ΔK̅ of the overall stiffness matrix is calculated:

$$Δ \overline{K} = - {\sum }_{j ∈ {Y}_{c}} {G}_{j}^{T} {Q}^{j} {G}_{j} ;$$

wherein, Y_{c} is the sequence of the newly added broken quasi-bonds, Gⱼ is a node freedom degree transformation matrix corresponding to the j^{th} quasi-bond in the Y_{c}, and Qⁱ is a bond element stiffness matrix of the j^{th} quasi-bond in the Y_{c}.

A calculation method of a breakage weight function μ(ξ, t) of the quasi-bond ξ_{I}^{i,j} in the t^{th} iteration is:

$$μ ( ξ , t ) = \{ \begin{matrix}1 , & l < {l}_{c} \\ 0 , & l \geq {l}_{c}\end{matrix} ;$$

wherein, I is an elongation of the quasi-bond, and I_{c} is a given critical elongation.

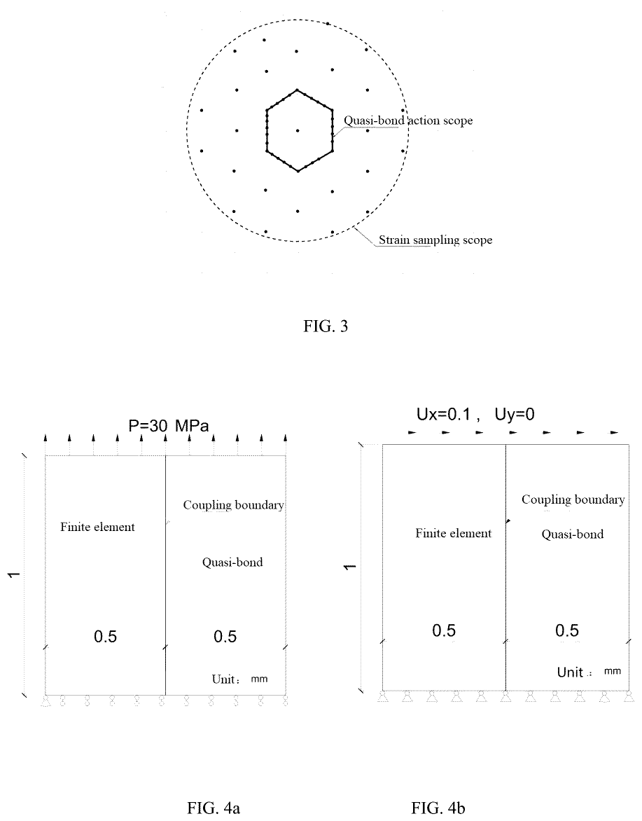

A strain sampling scope is constructed for any node, as shown in FIG. 3, the elongation I of the quasi-bond is calculated by using a smoothed strain ε̅_{I}, and calculation steps are as follows:

$$l = n \cdot {\overline{ε}}_{l} \cdot n ;$$

$$[ \begin{matrix}{\overline{ε}}_{l} \\ r\end{matrix} ] = {T}_{l} {U}_{l} ;$$

$${T}_{l} = {( {X}_{l}^{T} {X}_{l} )}^{- 1} {X}_{l}^{T} ;$$

$${X}_{l} = [ \begin{matrix}{x}_{1}^{1} & {x}_{2}^{1} & {x}_{3}^{1} & 1 \\ {x}_{1}^{2} & {x}_{2}^{2} & {x}_{3}^{2} & 1 \\ M & M & M & M \\ {x}_{1}^{v} & {x}_{2}^{v} & {x}_{3}^{v} & 1\end{matrix} ] ;$$

$${U}_{l} = [ \begin{matrix}{u}_{1}^{1} & {u}_{2}^{1} & {u}_{3}^{1} \\ {u}_{1}^{2} & {u}_{2}^{2} & {u}_{3}^{2} \\ M & M & M \\ {u}_{1}^{v} & {u}_{2}^{v} & {u}_{3}^{v}\end{matrix} ] ;$$

wherein, n is a direction vector n=ξ_{I}^{i,j}/∥ξ_{I}^{i,j}∥ of the quasi-bond ξ_{I}^{i,j}, T_{I}, is a smoothed strain transformation matrix, U_{I} is a matrix formed by displacements of all nodes in the strain sampling scope at the node I, and X_{I} is a position matrix of all nodes in the strain sampling scope at the node I; and in order to simplify expression, in the matrix, xₐ^{v} represents an a^{th} component of a position vector of a v^{th} node in the sampling scope, and uₐ^{v} represents an a^{th} component of a displacement vector of the v^{th} node in the sampling scope, a=1, 2, 3.

In step S6, an actual node displacement u=K̅−¹F after updating the overall stiffness matrix of the target structure body and an equivalent damage parameter d_{I} at each node are calculated, and cloud charts of a displacement field and an equivalent damage field are output.

In step S7, whether the load is applied completely is judged, and if the load is not applied completely, the step S3 is returned to calculate a next load; and if the load is applied completely, the calculation is ended; and

Step S8: carrying out grid sparsification on a continuous region and grid densification on a potential crack region to prevent damage and breakage of materials and structures based on the results of solid structure deformation and damage analysis method based on a quasi-bond finite element method through improving an assembly speed of the whole system stiffness matrix, using the finite element algorithm to naturally replace a continuous region and only using the quasi-bond method to calculate a potential crack region by utilizing a characteristic that the quasi-bond method and the finite element method both use a standard finite element grid for discretization.

The following description is given with reference to specific examples.

### Embodiment 1

In this embodiment, a plane stress problem is set, which is specifically a square lossless continuous plate, and a three-node triangular element is adopted in numerical calculation. As shown in FIG. 4, the deformation of the lossless continuous plate is simulated by stretching and shearing ways, and geometric dimensions and boundary conditions are shown in FIG. 4(a) and FIG. 4(b) respectively. A material of target structure has a Young's modulus of E=30 GPa and a Poisson's ratio of 1/3, and an assumed thickness of a plane is 1 mm.

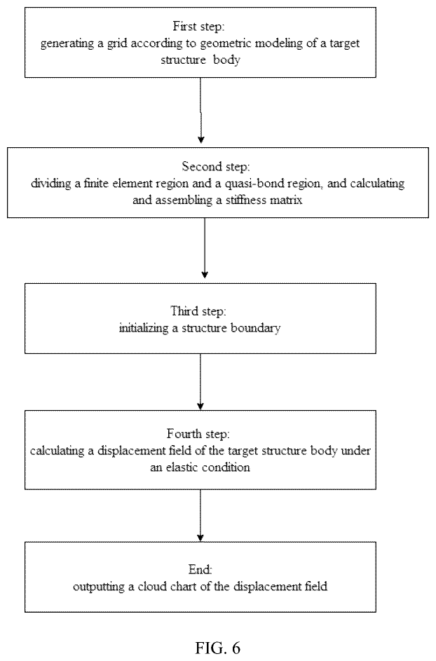

As shown in FIG. 6, a specific analysis method is as follows.
a. For the stretching way:

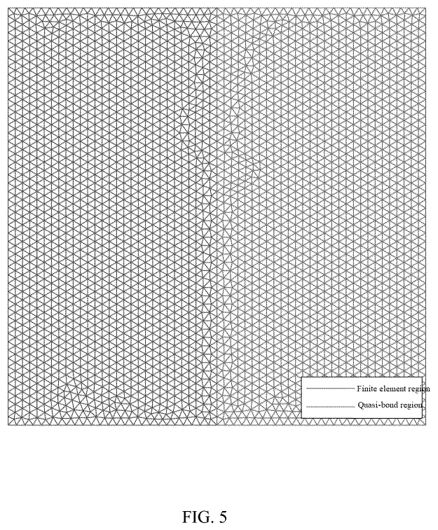

A grid is generated according to geometric modeling of a target structure body first, as shown in FIG. 5.

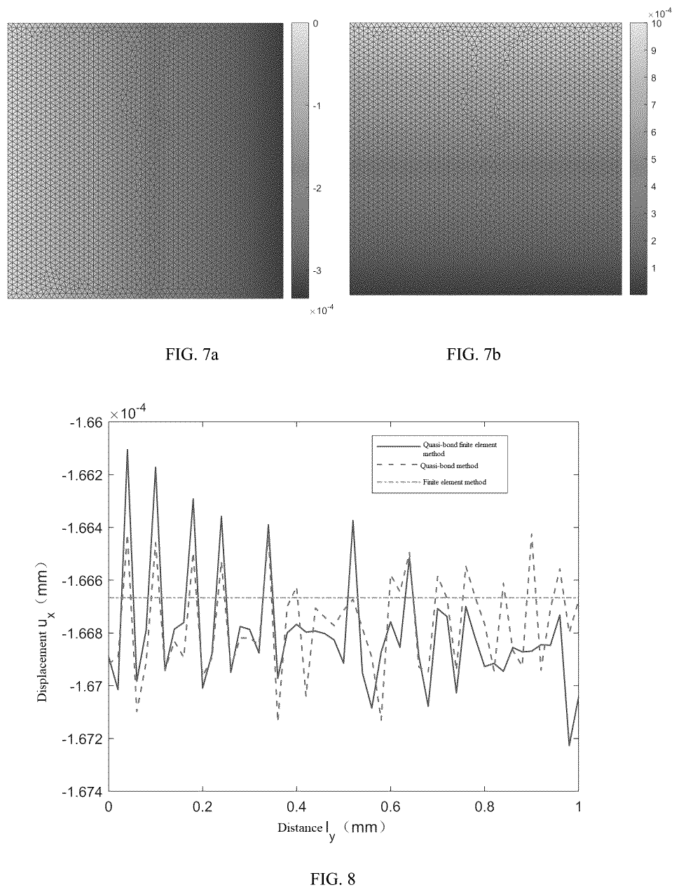

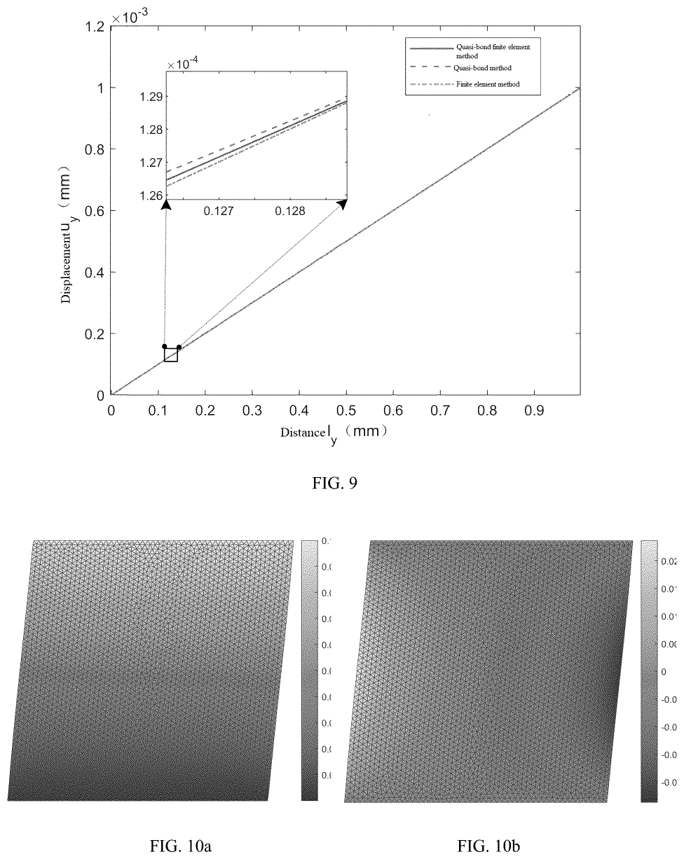

A preset force boundary is q=30 MPa, a cloud chart of a displacement of the target structure body is output according to a calculation result of each load, as shown in FIG. 7, and field variable quantities of the target structure body are drawn on an initial configuration of structure, showing colors from blue to yellow and numerical values from low to high. A cloud chart of a displacement of an overall node of a continuous plate in an x direction is shown in FIG. 7(a), and a cloud chart of a displacement in a y direction is shown in FIG. 7(b). A displacement of a coupling boundary node between a quasi-bond region and a finite element region in the x direction is shown in FIG. 8, and a displacement in the y direction is shown in FIG. 9.
a. For the shearing way:

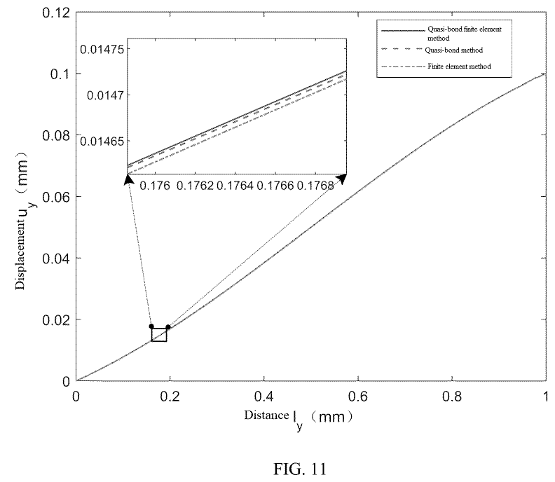

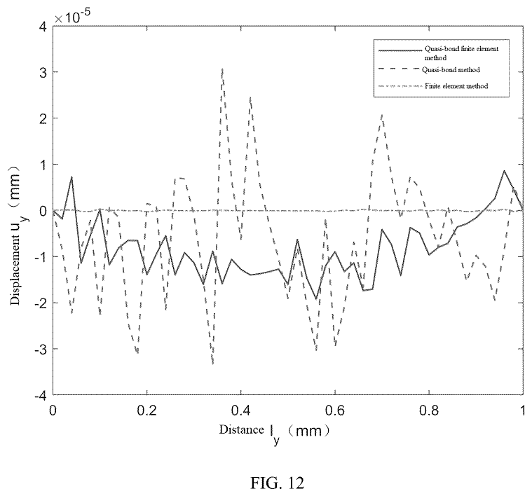

The coupling and calculation flow of the finite element and the quasi-bond element of the target structure body are consistent with the flow chart in the stretching way. A preset maximum load displacement is uₓ=0.1 mm, a cloud chart of a displacement of the target structure body is output according to a calculation result, as shown in FIG. 10, and field variable quantities of the target structure body are drawn on an initial configuration of structure, showing colors from blue to yellow and numerical values from low to high. A cloud chart of a displacement of an overall node of a continuous plate in an x direction is shown in FIG. 10(a), and a cloud chart of a displacement in a y direction is shown in FIG. 10(b). A displacement of a coupling boundary node between a quasi-bond and a finite element in the x direction is shown in FIG. 11, and a displacement in the y direction is shown in FIG. 12.

### Embodiment 2

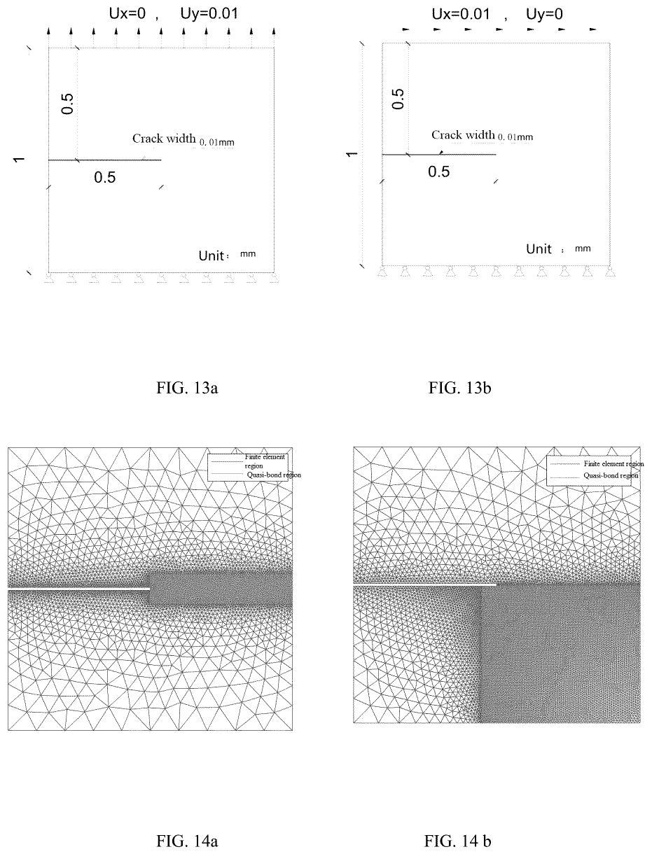

In this embodiment, a plane stress problem is set, which is specifically a square sheet with a prefabricated fracture, and a three-node triangular element is adopted in numerical calculation. As shown in FIG. 13, the deformation of the sheet is simulated by stretching and shearing ways, and geometric dimensions and boundary conditions are shown in FIG. 13(a) and FIG. 13(b) respectively. A material of target structure has a Young's modulus of E=30 GPa and a Poisson's ratio of 1/3, a critical elongation of a force bond is I_{c}=0.001, and a maximum allowable number of broken bonds is 10 each time, and an assumed thickness of a plane is 1 mm.

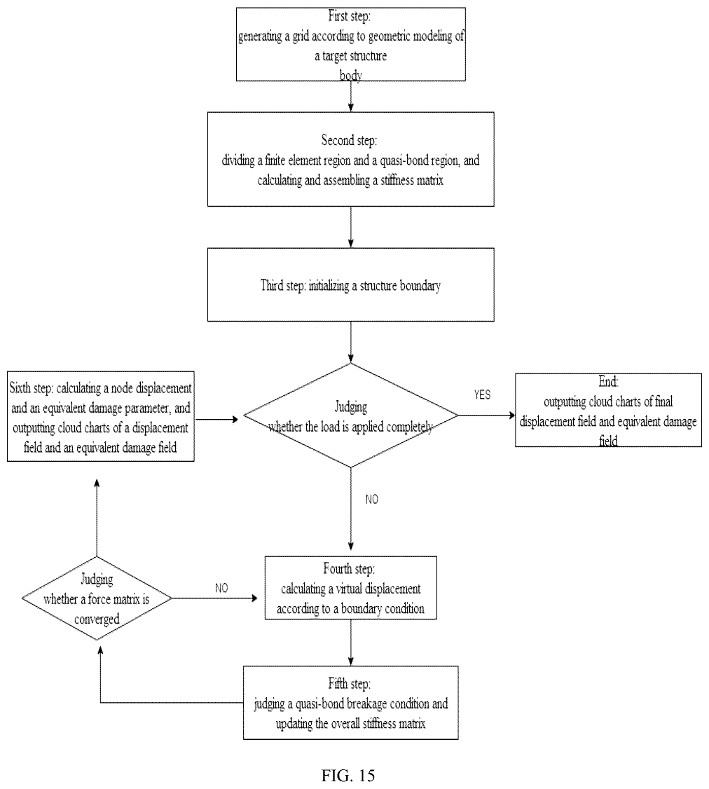

As shown in FIG. 15, a specific analysis method is as follows.

### 2.1 for the Stretching Way:

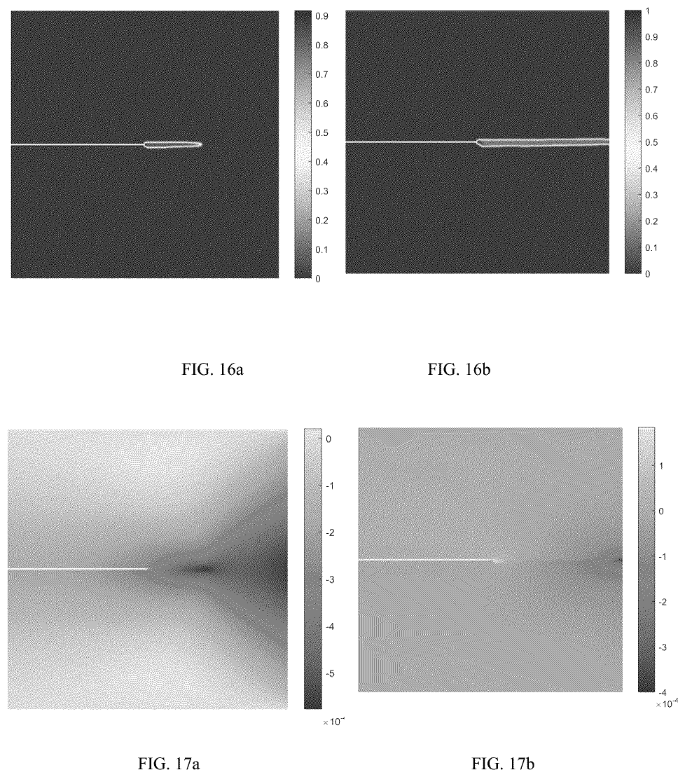

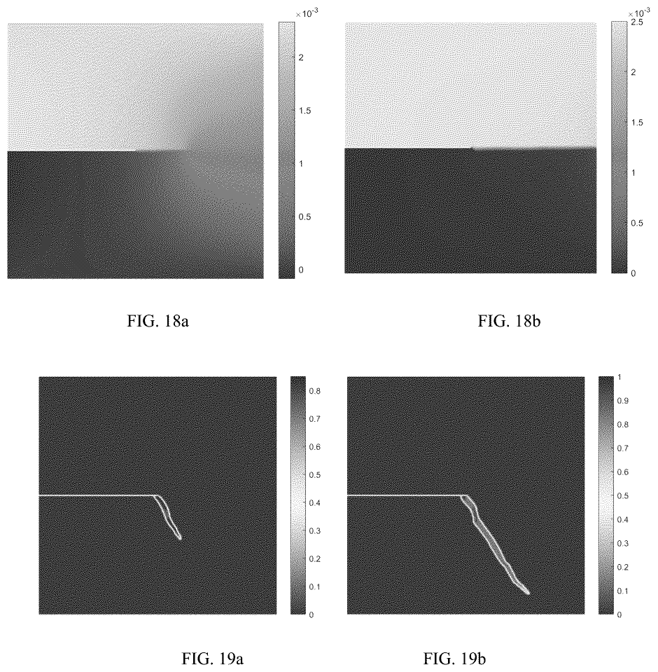

A grid is generated according to geometric modeling of a target structure body first, as shown in FIG. 14, wherein FIG. 14(a) is a diagram of a grid in a stretching calculating example. A preset displacement increment is 1×10⁻⁴ mm, a maximum load displacement is u_{y}=0.01 mm, cloud charts of an equivalent damage and a displacement of the target structure body are output according to a calculation result of each load, as shown in FIG. 16, FIG. 17 and FIG. 18, and field variable quantities of the target structure body are drawn on an initial configuration of structure, showing colors from blue to red and numerical values from low to high in an equivalent damage field, and showing colors from blue to yellow and numerical values from low to high in a displacement field. A cloud chart of an equivalent damage of an overall node the sheet is shown in FIG. 16, a cloud chart of an equivalent damage under a deformation of u_{y}=2.25×10⁻³ mm is shown in FIG. 16(a), and a cloud chart of an equivalent damage under a deformation of u_{y}=2.5×10⁻³ mm is shown in FIG. 16(b). Displacements of the target structure body in the x direction under deformations of u_{y}=2.25×10⁻³ mm and u_{y}=2.5×10⁻³ mm are respectively shown in FIG. 17(a) and FIG. 17(b), and displacements in the y direction are respectively shown in FIG. 18(a) and FIG. 18(b).

### 2.2 for the Shearing Way:

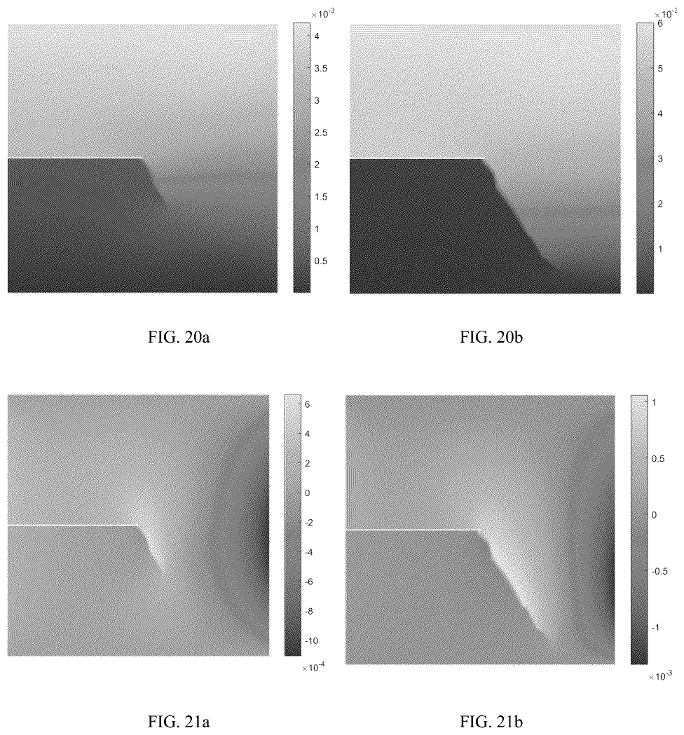

The coupling of the finite element and the quasi-bond element of the target structure body is shown in FIG. 14(b), and the calculation flow is consistent with the flow chart in the stretching way. A preset displacement increment is 5×10−5 mm, a maximum load displacement is uₓ=0.01 mm, cloud charts of an equivalent damage and a displacement of the target structure body are output according to a calculation result, as shown in FIG. 19, FIG. 20 and FIG. 21, and field variable quantities of the target structure body are drawn on an initial configuration of structure, showing colors from blue to red and numerical values from low to high in an equivalent damage field, and showing colors from blue to yellow and numerical values from low to high in a displacement field. A cloud chart of an equivalent damage of an overall node the sheet is shown in FIG. 19, a cloud chart of an equivalent damage under a displacement load of uₓ=4.2×10⁻³ mm is shown in FIG. 19(a), and a cloud chart of an equivalent damage under a displacement load of uₓ=6.0×10⁻³ mm is shown in FIG. 19(b). Displacements of the target structure body in the x direction under displacement loads of uₓ=4.2×10⁻³ mm and uₓ=6.0×10⁻³ mm are respectively shown in FIG. 20(a) and FIG. 20(b), and displacements in they direction are shown in FIG. 21(a) and FIG. 21(b).

### Embodiment 3

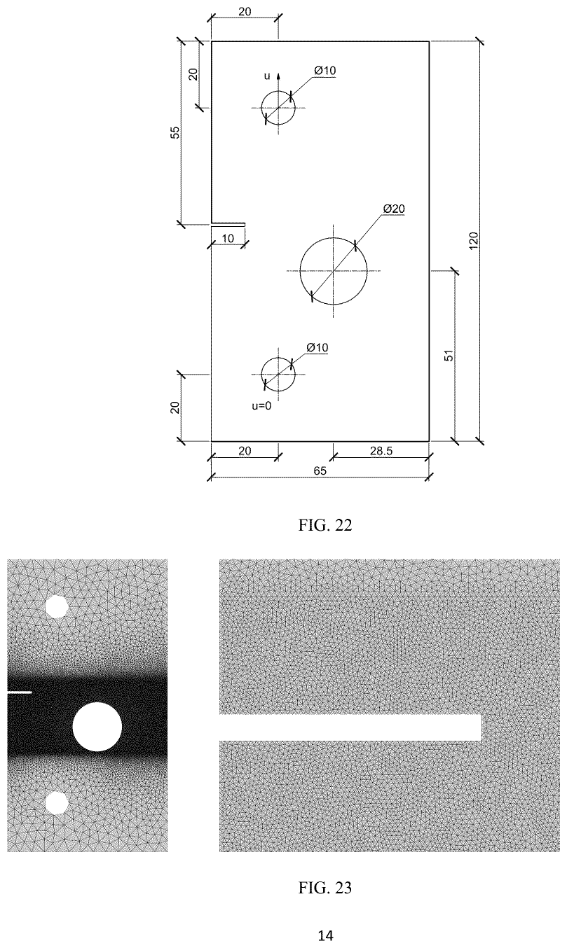

In this embodiment, a plane stress problem is set, which is specifically a rectangular sheet with three round holes and a prefabricated fracture, and a three-node triangular element is adopted in numerical calculation. The deformation of the sheet is simulated by a stretching way, and a geometric dimension and a boundary condition are shown in FIG. 22. A material of target structure body has a Young's modulus of E=5.89 GPa and a Poisson's ratio of 1/3, a critical elongation of a force bond is I_{c}=0.011, and a maximum allowable number of broken bonds is 10 each time, and an assumed thickness of a plane is 1 mm.

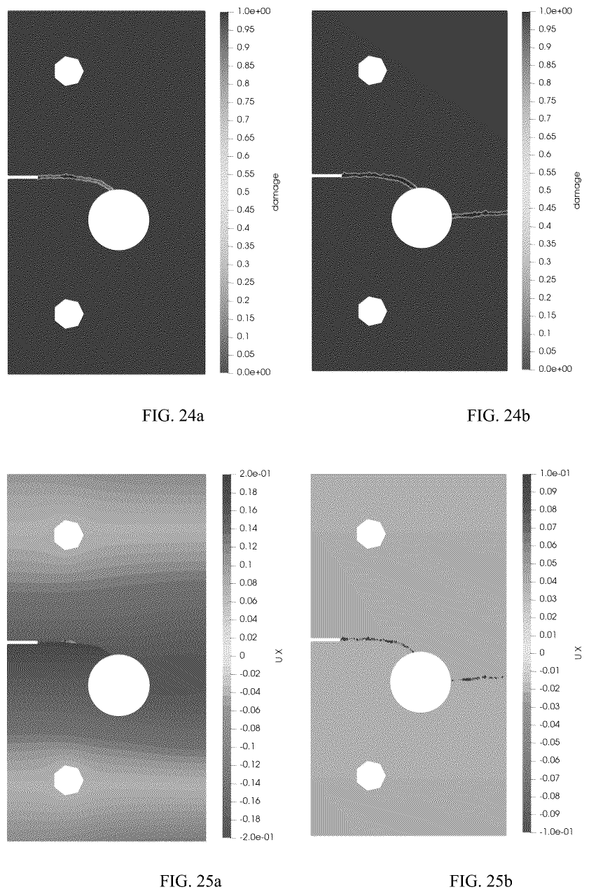

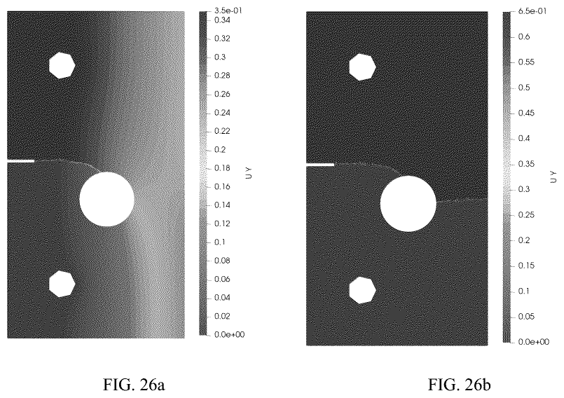

A grid is generated according to geometric modeling of the target structure body, and a grid in a high-probability damage region is densified, as shown in FIG. 23. A preset displacement increment is 1×10⁻³ mm, and a maximum load displacement is u_{y}=1 mm. Cloud charts of an equivalent damage and a displacement of the target structure body are output according to a calculation result of each load, as shown in FIG. 24, FIG. 25 and FIG. 26, and field variable quantities of the target structure body are drawn on an initial configuration of structure, showing colors from blue to red and numerical values from low to high in an equivalent damage field, and showing colors from blue to yellow and numerical values from low to high in a displacement field. A cloud chart of an equivalent damage of an overall node the sheet is shown in FIG. 24, a cloud chart of an equivalent damage under a deformation of u_{y}=3.5×10⁻¹ mm is shown in FIG. 24(a), and a cloud chart of an equivalent damage under a deformation of u_{y}=6.44×10⁻¹ mm is shown in FIG. 24(b). Displacements of the target structure body in the x direction under deformations of u_{y}=3.5×10⁻¹ mm and u_{y}=6.44×10⁻¹ mm are respectively shown in FIG. 25(a) and FIG. 25(b), and displacements in the y direction are respectively shown in FIG. 26(a) and FIG. 26(b).

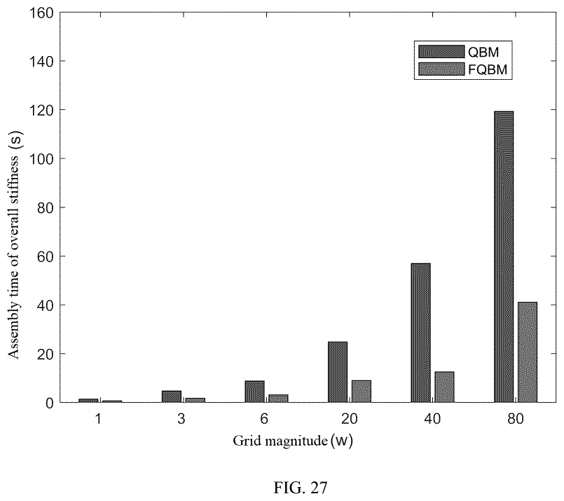

In order to highlight an improvement effect of a quasi-bond finite element method on calculation efficiency, models with grid magnitudes of 1 w, 3 w, 6 w, 20 w, 40 w and 80 w are constructed for the target structure body respectively, and the target structure body is calculated by a quasi-bond method and the quasi-bond finite element method respectively. Calculation results are shown in FIG. 27 and Table 1. It can be seen that the quasi-bond finite element method has obvious advantages in assembling an overall stiffness matrix, and can greatly reduce calculation time.

TABLE 1
Comparison of assembly speeds of whole stiffness matrix of target structure body by finite
element method and quasi-bond finite element method respectively in Embodiment 3

| | Grid magnitude | | | | | |
|---|---|---|---|---|---|---|
| | 1 w | | 3 w | | 6 w | |
| | Number of elements | | | | | |
| | 9805 | | 35398 | | 67993 | |
| | Method | | | | | |
| | QBM | FQBM | QBM | FQBM | QBM | FQBM |
| Number of elements | 9805 | 3825 | 35398 | 7068 | 67993 | 15281 |
| in quasi-bond region | | | | | | |
| Assembly time of overall | 1.3512 | 0.6625 | 4.692 | 1.7219 | 8.7857 | 3.11 |
| stiffness (s) | | | | | | |
| | Grid magnitude | | | | | |
| | 20 w | | 40 w | | 80 w | |
| | Number of elements | | | | | |
| | 190585 | | 423680 | | 871183 | |
| | Method | | | | | |
| | QBM | FQBM | QBM | FQBM | QBM | FQBM |
| Number of elements | 190585 | 43701 | 423680 | 94626 | 871183 | 172054 |
| in quasi-bond region | | | | | | |
| Assembly time of overall | 24.7843 | 8.9523 | 56.9879 | 12.5295 | 119.2899 | 41.0864 |
| stiffness (s) | | | | | | |

QBM represents the quasi-bond method and FQBM represents the quasi-bond finite element method.

### Embodiment 4

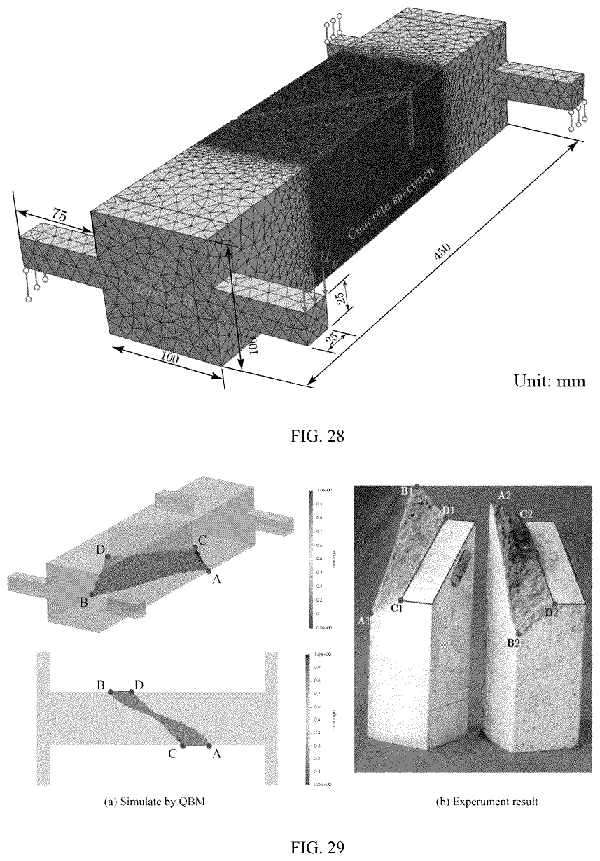

In this embodiment, a three-dimensional problem is set, which is specifically a concrete beam with an inclined prefabricated fracture, and a four-node tetrahedron element is adopted in numerical calculation. The concrete beam is twisted by a steel fixture and the deformation and damage of the concrete beam are simulated, and a geometric dimension, a boundary condition and a grid are shown in FIG. 28. The concrete beam in the target structure body has a Young's modulus of E=35 GPa and a Poisson's ratio of v=1/4, a material of the steel fixture in the target structure body has a Young's modulus of 200 GPa and a Poisson's ratio of v=0.2, a critical elongation of a force bond is I_{c}=0.0011, and a maximum allowable number of broken keys is Nₘ=32 each time. The concrete beam is calculated by a quasi-bond method and the steel fixture is calculated by a finite element method.

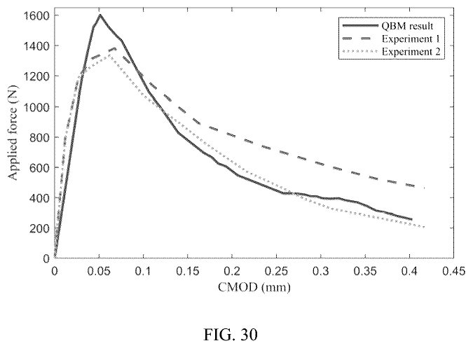

A grid is generated according to geometric modeling of the target structure body, and a grid in a high-probability damage region is densified. A preset displacement increment is Δu_{y}=5×10⁻³ mm, and a maximum load displacement is u_{y}=5 mm. A cloud chart of a damage of a damaged target sample is recorded as shown in FIG. 29(a), and field variable quantities of the target structure body are drawn on an initial configuration of structure, showing colors from blue to red and numerical values from low to high in an equivalent damage field. Reference results of corresponding physical object experiment are shown in FIG. 29(b). In a loading process, a curve relationship between a prefabricated fracture tip opening displacement (CMOD) and a reaction force resultant force of a loading surface is recorded and compared with an experiment result. Results are shown in FIG. 30.

It can be seen from the above embodiments that this method can well simulate the deformation characteristics and damage evolution process of the continuum and the quasi-brittle material with the prefabricated fracture under different external loads, and the calculation results are basically consistent with actual situations. Meanwhile, this method combines the finite element method with the quasi-bond method, and can accurately predict the damage of the local crack of the target structure body by changing the position and scope of the quasi-bond region on the basis of ensuring the calculation accuracy of the continuous region. Compared with the standard quasi-bond calculation, this method greatly improves the assembly speed of the stiffness matrix of the target structure body, reduces the assembly difficulty, and adapts to the calculation accuracy and efficiency requirement of large-scale model, thereby having an important application value in large-scale engineering fields such as civil water conservancy, energy exploitation and strategic material storage.

The above embodiments are only examples for clearly illustrating the present invention, but are not intended to limit the implementations of the present invention. For those of ordinary skills in the art, other different forms of changes or variations may be made on the basis of the above description. It is not necessary or possible to exhaust all the implementations herein. Moreover, the obvious changes or variations derived from this are still included in the scope of protection of the present invention.

What is claimed is:

1. A solid structure deformation and damage analysis method based on a quasi-bond finite element method, comprising a non-transitory computer readable medium operable on a computer with memory for the solid structure deformation and damage analysis method based on a quasi-bond finite element method, and comprising program instructions for executing the following steps of:
step S1: carrying out geometric modeling on a target structure body Ω, and carrying out distribution and subdivision on a model boundary to generate a grid of a traditional finite element method, so as to obtain several elements and nodes;
step S2: presetting a fracture on the target structure body Ω, and dividing the target structure body Ω into a finite element calculation region Ω_{FEM} and a quasi-bond calculation region Ω_{QBM}, wherein a potential occurrence region of fracture and crack is located in the quasi-bond calculation region Ω_{QBM},
step S3: setting a boundary condition for the target structure body Ω, applying an external load, and calculating a force matrix F, a finite element region system stiffness matrix K̅_{FEM} and a quasi-bond region system stiffness matrix K̅_{QBM} of the target structure body under the load and boundary state, and an overall stiffness matrix K̅ of the target structure body, K̅=K̅_{FEM}+K̅_{QBM};
step S4: setting the target structure body as an elastic material, calculating an initial node displacement vector u^{trial}, wherein the u^{trial} is equal to multiplication of an initial overall stiffness matrix of the target structure body and an initial force matrix, and judging a quasi-bond breakage condition according to the initial node displacement vector u^{trial};
step S5: carrying out iteration under current load, and updating the overall stiffness matrix K̅ of the target structure body, K̅=K̅^{cur}+ΔK̅, wherein K̅^{cur} is an overall stiffness matrix of the target structure body before updating, which is namely an overall stiffness matrix of the target structure body after previous iteration; and ΔK̅ is a variable quantity of the overall stiffness matrix of the target structure body; and
calculating a convergence index after each iteration, and if the convergence index is less than a given error tolerance value, stopping the iteration, and entering step S6; and if the convergence index is greater than or equal to the given error tolerance value, continuously carrying out iteration;
step S6: calculating an actual node displacement u=K̅⁻¹F after updating the overall stiffness matrix of the target structure body and an equivalent damage parameter d_{I}, at each node, and outputting cloud charts of a displacement field and an equivalent damage field;
step S7: judging whether the load is applied completely, and if the load is not applied completely, returning to the step S3 to calculate a next load; and if the load is applied completely, ending the calculation; and
Step S8: carrying out grid sparsification on a continuous region and grid densification on a potential crack region to prevent damage and breakage of materials and structures based on the results of solid structure deformation and damage analysis method based on a quasi-bond finite element method.

2. The solid structure deformation and damage analysis method based on the quasi-bond finite element method according to claim 1, wherein, in the step S3, for a two-dimensional structure body, calculation steps of the quasi-bond region system stiffness matrix K̅_{QBM} of the target structure body Ω are as follows:
A1: acquiring a quasi-bond, wherein the grid of the traditional finite element method generated by subdividing the target structure body Ω subjected to distribution is a three-node triangular element; e_{I} elements Ω_{I}ⁱ connected with any node I are determined, i=1, 2, . . . , e_{I}, a cluster of rays with a number of N_{I} starting from an x axis are generated at any node I at equal angles, the rays are quasi-bonds, one of the quasi-bonds intersects with a line segment formed by a node J and a node K at a point p_{I}^{i,j}, a position vector of the point p_{I}^{i,j} is x_{I}^{i,j}, a position vector of the node I is x_{I}, a j^{th} quasi-bond ξ_{I}^{i,j}=x_{I}^{i,j}−x_{I} in an i^{th} element at the node I is obtained, and a total number of quasi-bonds at the node I is N_{I}; wherein, an included angle between any two adjacent quasi-bonds is Δθ, a number of quasi-bonds in the element Q_{I}ⁱ is N_{I}ⁱ, ·_{I}^{i,j} represents a certain value of the j^{th} quasi-bond in the i^{th} element connected with the node I, and a quasi-bond intersecting with a prefabricated fracture is a failed quasi-bond;
A2: calculating a bond force, wherein the bond force f_{I}^{i,j} is calculated according to the following formula:
$${f}_{l}^{i , j} = {D}_{l}^{i , j} {η}_{l}^{i , j} ;$$
$${D}_{l}^{i , j} = \frac{c μ ( ξ , t )}{{‖ ξ ‖}^{4}} [ \begin{matrix}{ξ}_{x}^{2} & {ξ}_{x} {ξ}_{y} \\ {ξ}_{y} {ξ}_{x} & {ξ}_{y}^{2}\end{matrix} ] ;$$
in order to simplify expression, ξ is used in the formula to refer to ξ_{I}^{i,j}, ξₓ and ξ_{y} are components of the quasi-bond ξ_{I}^{i,j} in x and y directions, η_{I}^{i,j} is a relative deformation vector of the quasi-bond, η_{I}^{i,j} is expressed by a strain ε_{I}ⁱ of an element where the quasi-bond ξ_{I}^{i,j} is located, η_{I}^{i,j}=ε_{I}ⁱ·ξ_{I}^{i,j}, D_{I}^{i,j} is a quasi-bond stiffness matrix, μ(ξ, t) is a breakage weight function of the quasi-bond ξ_{I}^{i,j} in a t^{th} iteration, and c is a quasi-bond stiffness; and
A3: calculating the quasi-bond region system stiffness matrix, wherein a node force resultant force of the node I is composed of a bond force resultant force q_{I} and a reaction force resultant force brought to the node I when bond forces of quasi-bonds at other nodes are calculated,
$${q}_{l} = {\sum }_{i = 1}^{{e}_{l}} {\sum }_{j = 1}^{{N}_{l}^{i}} {f}_{l}^{i , j} {A}^{i} h / {N}^{i} ,$$
and accordingly, a calculation formula of the quasi-bond region system stiffness matrix K of the target structure body is as follows:
$${\overline{K}}_{QBM} = {\sum }_{l = 1}^{0} {K}_{l} ;$$
$${K}_{l} = {\sum }_{i = 1}^{{e}_{l}} {\sum }_{j = 1}^{{N}_{l}^{i}} {G}_{i}^{T} {Q}_{l}^{i , j} {G}_{i} ;$$
$${Q}_{l}^{i , j} = {W}_{l} [ \begin{matrix}- D & {λ}_{K} D & {λ}_{J} D \\ {λ}_{K} D & - {λ}_{K}^{2} D & - {λ}_{K} {λ}_{J} D \\ {λ}_{J} D & - {λ}_{J} {λ}_{K} D & - {λ}_{J}^{2} D\end{matrix} ] ;$$
$${W}_{l} = {A}^{i} h / {N}^{i} ;$$
wherein, e_{I} represents a number of quasi-bond elements connected with the node I, Nⁱ is a total number of quasi-bonds in the i^{th} element, N_{I}ⁱ represents a number of quasi-bonds in each element connected with the node I, Aⁱ is an area of the i^{th} element, h is a model thickness, o represents a number of nodes in the quasi-bond region in the target structure body, Gᵢ is a node freedom degree transformation matrix of the i^{th} element, ·^{T} represents matrix transposition, and Q_{I}^{i,j} represents an element stiffness matrix under a combined action of a bond force and a bond force reaction force at the node I; for the two-dimensional structure body, Nⁱ≈π/Δθ; W_{I} is a quasi-bond volume differential element at the node I; and in order to simplify expression, elements in the matrix are λ_{K}=λ_{K}^{i,j}, λ_{J}=λ_{J}^{i,j} and D=D_{I}^{i,j}.

3. The solid structure deformation and damage analysis method based on the quasi-bond finite element method according to claim 2, wherein, in the step A2, according to assumption of small deformation, a relative deformation vector of any quasi-bond ξ_{I}^{i,j} is expressed as η_{I}^{i,j}=ε_{I}ⁱξ_{I}^{i,j}, wherein ε_{I}ⁱ represents an element strain of the i^{th} element connected with the node I; and in order to simplify calculation, the element strain is calculated by using an element node displacement column vector, ε_{I}ⁱ=B_{I}ⁱU_{I}ⁱ, and a matrix calculation method of a quasi-bond force density f_{I}^{i,j} is updated as:
$${f}_{l}^{i , j} = {D}_{l}^{i , j} {X}_{l}^{i , j} {B}_{l}^{i} {U}_{l}^{i} ;$$
$${X}_{l}^{i , j} = [ \begin{matrix}{ξ}_{x} & 0 & \frac{1}{2} {ξ}_{y} \\ 0 & {ξ}_{y} & \frac{1}{2} {ξ}_{x}\end{matrix} ] ;$$
$${U}_{l}^{i} = {[ \begin{matrix}{u}_{1}^{x} & {u}_{1}^{y} & {u}_{2}^{x} & {u}_{2}^{y} & {u}_{3}^{x} & {u}_{3}^{y}\end{matrix} ]}^{T} ;$$
$${B}_{i} = [ \begin{matrix}\frac{\partial {N}_{1}}{\partial x} & 0 & \frac{\partial {N}_{2}}{\partial x} & 0 & \frac{\partial {N}_{3}}{\partial x} & 0 \\ 0 & \frac{\partial {N}_{1}}{\partial y} & 0 & \frac{\partial {N}_{2}}{\partial y} & 0 & \frac{\partial {N}_{3}}{\partial y} \\ \frac{\partial {N}_{1}}{\partial y} & \frac{\partial {N}_{1}}{\partial x} & \frac{\partial {N}_{2}}{\partial y} & \frac{\partial {N}_{2}}{\partial x} & \frac{\partial {N}_{3}}{\partial y} & \frac{\partial {N}_{3}}{\partial x}\end{matrix} ] ;$$
wherein, D_{I}^{i,j} is a bond stiffness matrix of the quasi-bond ξ_{I}^{i,j}, B_{I}ⁱ is a shape function gradient matrix of the i^{th} element connected with the node I, x_{I}^{i,j}, is a relative position transformation matrix of the quasi-bond ξ_{I}^{i,j}, and u_{I}ⁱ is a node displacement column vector of the i^{th} element; and in order to simplify expression, ξₓ and ξ_{y} in the matrix are components of the quasi-bond ξ_{I}^{i,j} in x and y directions, uₐ^{x} and uₐ^{y} represent components of a node displacement of the i^{th} element in x and y directions, and Nₐ is a shape function of the i^{th} element at each node, a=1, 2, 3.

4. The solid structure deformation and damage analysis method based on the quasi-bond finite element method according to claim 1, wherein, in the step S3, for a three-dimensional structure body, calculation steps of the quasi-bond region system stiffness matrix K̅_{QBM} are as follows:
B1: acquiring a quasi-bond, wherein the grid of the traditional finite element method generated by subdividing the target structure body subjected to distribution is a four-node tetrahedral element; e_{I} elements Ω_{I}ⁱ connected with any node I are determined, i=1, 2, . . . , e_{I}, a cluster of rays with a number of N_{I} starting from an x axis are generated at any node I at equal angles, the rays are quasi-bonds, one of the quasi-bonds intersects with a plane formed by a node J, a node K and a node L at a point p_{I}^{i,j}, a position vector of the point p_{I}^{i,j} is x_{I}^{i,j}, a position vector of the node I is x_{I}, a j^{th} quasi-bond ξ_{I}^{i,j}=x_{I}^{i,j}−x_{I} in an i^{th} element at the node I is obtained, and a total number of quasi-bonds at the node I is N_{I}; wherein, a stereoscopic included angle between any two adjacent quasi-bonds is Δω, a number of quasi-bonds in the element Ω_{I}ⁱ is N_{I}ⁱ, ·_{I}^{i,j} represents a certain value of the j^{th} quasi-bond in the i^{th} element connected with the node I, and a quasi-bond intersecting with a prefabricated fracture is a failed quasi-bond;
B2: calculating a bond force, wherein the bond force f_{I}^{i,j} is calculated according to the following formula:
$${f}_{l}^{i , j} = {D}_{l}^{i , j} {η}_{l}^{i , j} ;$$
$${D}_{l}^{i , j} = \frac{c μ ( ξ , t )}{{‖ ξ ‖}^{4}} [ \begin{matrix}{ξ}_{x}^{2} & {ξ}_{x} {ξ}_{y} & {ξ}_{x} {ξ}_{z} \\ {ξ}_{y} {ξ}_{x} & {ξ}_{y}^{2} & {ξ}_{y} {ξ}_{z} \\ {ξ}_{z} {ξ}_{x} & {ξ}_{z} {ξ}_{y} & {ξ}_{z}^{2}\end{matrix} ] ;$$
in order to simplify expression, ξ is used in the formula to refer to ξ_{I}^{i,j}, ξₓ, ξ_{y} and ξ_{z} are components of the quasi-bond ξ_{I}^{i,j} in x, y and z directions, η_{I}^{i,j} is a relative deformation vector of the quasi-bond, η_{I}^{i,j} is expressed by a strain ε_{I}ⁱ of an element where the quasi-bond ξ_{I}^{i,j} is located, η_{I}^{i,j}=ε_{I}ⁱ·ξ_{I}^{i,j}, D_{I}^{i,j} is a quasi-bond stiffness matrix, μ(ξ, t) is a breakage weight function of the quasi-bond ξ_{I}^{i,j} in a t^{th} iteration, and c is a quasi-bond stiffness; and
B3: calculating the quasi-bond region stiffness matrix, wherein a node force resultant force of the node I is composed of a bond force resultant force q_{I} and a reaction force resultant force brought to the node I when bond forces of quasi-bonds at other nodes are calculated,
$${q}_{l} = {\sum }_{i = 1}^{{e}_{l}} {\sum }_{j = 1}^{{N}_{l}^{i}} {f}_{l}^{i , j} {V}^{i} / {N}^{i} ,$$
and a calculation formula of the quasi-bond region stiffness matrix K̅_{QBM} of the target structure body is as follows:
$${\overline{K}}_{QBM} = {\sum }_{l = 1}^{0} {\overline{K}}_{l} ;$$
$${\overline{K}}_{l} = {\sum }_{i = 1}^{{e}_{l}} {\sum }_{j = 1}^{{N}_{l}^{i}} {G}_{i}^{T} {Q}_{l}^{i , j} {G}_{i} ;$$
$${Q}_{l}^{i , j} = {W}_{l} [ \begin{matrix}- D & {s}_{J} D & {s}_{K} D & {s}_{L} D \\ {s}_{J} D & - {s}_{J}^{2} D & - {s}_{J} {s}_{K} D & - {s}_{J} {s}_{L} D \\ {s}_{K} D & - {s}_{J} {s}_{K} D & - {s}_{K}^{2} D & - {s}_{K} {s}_{L} D \\ {s}_{L} D & - {s}_{J} {s}_{K} D & - {s}_{K} {s}_{L} D & - {s}_{L}^{2} D\end{matrix} ] ;$$
$${W}_{l} = {V}^{i} / {N}^{i} ;$$
wherein, e_{I} represents a number of quasi-bond elements connected with the node I, Nⁱ is a total number of quasi-bonds in the i^{th} element, N_{I}ⁱ represents a number of quasi-bonds in each element connected with the node I, Vⁱ is a volume of the i^{th} element, o represents a number of nodes in the quasi-bond region in the target structure body, Gᵢ is a node freedom degree transformation matrix of the i^{th} element, ·^{T} represents matrix transposition, and Q_{I}^{i,j} represents an element stiffness matrix under a combined action of a bond force and a bond force reaction force at the node I; in the three-dimensional structure body,
$${N}^{i} \approx {\sum }_{g = 1}^{4} {ω}_{i , g} / Δω ; {ω}_{i , g}$$
is a stereoscopic included angle of a g^{th} node in the i^{th} element, and W_{I} is a quasi-bond volume differential element at the node I; and in order to simplify expression, elements in the matrix are S_{K}=S_{K}^{i,j}, S_{J}=S_{J}^{i,j}, s_{L}=s_{L}^{i,j} and D=D_{I}^{i,j}.

5. The solid structure deformation and damage analysis method based on the quasi-bond finite element method according to claim 4, wherein, in the step B2, according to assumption of small deformation, a relative deformation vector η_{I}^{i,j} of any quasi-bond ξ_{I}^{i,j} is expressed as η_{I}^{i,j}=ε_{I}ⁱξ_{I}^{i,j}, wherein ε_{I}^{i,j} represents an element strain of the i^{th} element connected with the node I; and in order to simplify calculation, the element strain is calculated by using an element node displacement column vector, ε_{I}ⁱ=B_{I}ⁱU_{I}ⁱ, and a matrix calculation method of a quasi-bond force f_{I}^{i,j} is updated as:
$${f}_{l}^{i , j} = {D}_{l}^{i , j} {X}_{l}^{i , j} {B}_{l}^{i} {U}_{l}^{i} ;$$
$${X}_{l}^{i , j} = [ \begin{matrix}{ξ}_{x} & 0 & 0 & 0 & \frac{1}{2} {ξ}_{z} & \frac{1}{2} {ξ}_{y} \\ 0 & {ξ}_{y} & 0 & \frac{1}{2} {ξ}_{z} & 0 & \frac{1}{2} {ξ}_{x} \\ 0 & 0 & {ξ}_{z} & \frac{1}{2} {ξ}_{y} & \frac{1}{2} {ξ}_{x} & 0\end{matrix} ] ;$$
$${U}_{l}^{i} = {[ \begin{matrix}{u}_{1}^{x} & {u}_{1}^{y} & {u}_{1}^{z} & {u}_{2}^{x} & {u}_{2}^{y} & {u}_{2}^{z} & {u}_{3}^{x} & {u}_{3}^{y} & {u}_{3}^{z} & {u}_{4}^{x} & {u}_{4}^{y} & {u}_{4}^{z}\end{matrix} ]}^{T} ;$$
$${B}_{i} = [ \begin{matrix}\frac{\partial {N}_{1}}{\partial x} & 0 & 0 & \frac{\partial {N}_{2}}{\partial x} & 0 & 0 & \frac{\partial {N}_{3}}{\partial x} & 0 & 0 & \frac{\partial {N}_{4}}{\partial x} & 0 & 0 \\ 0 & \frac{\partial {N}_{1}}{\partial y} & 0 & 0 & \frac{\partial {N}_{2}}{\partial y} & 0 & 0 & \frac{\partial {N}_{3}}{\partial y} & 0 & 0 & \frac{\partial {N}_{4}}{\partial y} & 0 \\ 0 & 0 & \frac{\partial {N}_{1}}{\partial z} & 0 & 0 & \frac{\partial {N}_{2}}{\partial z} & 0 & 0 & \frac{\partial {N}_{3}}{\partial z} & 0 & 0 & \frac{\partial {N}_{4}}{\partial z} \\ 0 & \frac{\partial {N}_{1}}{\partial z} & \frac{\partial {N}_{1}}{\partial y} & 0 & \frac{\partial {N}_{2}}{\partial z} & \frac{\partial {N}_{2}}{\partial y} & 0 & \frac{\partial {N}_{3}}{\partial z} & \frac{\partial {N}_{3}}{\partial y} & 0 & \frac{\partial {N}_{4}}{\partial z} & \frac{\partial {N}_{4}}{\partial y} \\ \frac{\partial {N}_{1}}{\partial z} & 0 & \frac{\partial {N}_{1}}{\partial x} & \frac{\partial {N}_{2}}{\partial z} & 0 & \frac{\partial {N}_{2}}{\partial x} & \frac{\partial {N}_{3}}{\partial z} & 0 & \frac{\partial {N}_{3}}{\partial x} & \frac{\partial {N}_{4}}{\partial z} & 0 & \frac{\partial {N}_{4}}{\partial x} \\ \frac{\partial {N}_{1}}{\partial y} & \frac{\partial {N}_{1}}{\partial x} & 0 & \frac{\partial {N}_{2}}{\partial y} & \frac{\partial {N}_{2}}{\partial x} & 0 & \frac{\partial {N}_{3}}{\partial y} & \frac{\partial {N}_{3}}{\partial x} & 0 & \frac{\partial {N}_{4}}{\partial y} & \frac{\partial {N}_{4}}{\partial x} & 0\end{matrix} ] ;$$
wherein, D_{I}^{i,j} is a bond stiffness matrix of the quasi-bond ξ_{I}^{i,j}, B_{I}ⁱ is a shape function gradient matrix of the i^{th} element connected with the node I, x_{I}^{i,j} is a relative position transformation matrix of the quasi-bond ξ_{I}^{i,j}, and u_{I}ⁱ is a node displacement column vector of the i^{th} element; and in order to simplify expression, ξₓ, ξ_{y} and ξ_{z} in the matrix are components of the quasi-bond ξ_{I}^{i,j} in x, y and z directions, uₐ^{x}, uₐ^{y} and uₐ^{z} respectively represent components of a node displacement of the i^{th} element in x, y and z directions, and Nₐ is a shape function of the i^{th} element at each node, a=1, 2, 3, 4.

6. The solid structure deformation and damage analysis method based on the quasi-bond finite element method according to claim 1, wherein, in the step S3, calculation steps of the finite element region system stiffness matrix K̅_{FEM} are as follows:
$${\overline{K}}_{FEM} = - {\sum }_{i = 1}^{{m}_{F}} {G}_{i}^{T} {Re}^{j} {G}_{i} ;$$
$${Re}^{j} = {\int }_{{Ω}_{i}} {B}_{i}^{T} {CB}_{i} d Ω ;$$
wherein, m_{F} is a number of elements in a finite element region Ω_{fEM}, Gᵢ is a node freedom degree transformation matrix of the i^{th} element Ωᵢ in the finite element region Ω_{fEM}, which satisfies u=Gᵢu, u is an overall node displacement vector of the target structure body, and u is a node displacement vector of the i^{th} element; and Reⁱ is an element stiffness matrix of the i^{th} element Ωᵢ, Bᵢ is a shape function gradient matrix of the i^{th} element, and C is a finite element elasticity matrix.

7. The solid structure deformation and damage analysis method based on the quasi-bond finite element method according to claim 6, wherein, in the step S3, calculation steps of a force matrix F of the target structure body are as follows: an external load of the force matrix F of the target structure body is distributed to the node, so as to obtain that contributions of the quasi-bond region and the finite element region to the force matrix F of the target structure body are the same, and calculation methods are the same, which are both as follows:
$$F = {\sum }_{i = 1}^{m} {G}_{i}^{T} {F}_{i} ;$$
$${F}_{i} = {\int }_{{Ω}_{i}} {N}_{i}^{T} bd Ω ;$$
$${N}_{i} = [ \begin{matrix}{N}_{1} & 0 & 0 & L & {N}_{dim} & 0 & 0 \\ 0 & O & 0 & L & 0 & O & 0 \\ 0 & 0 & {N}_{1} & L & 0 & 0 & {N}_{dim}\end{matrix} ] ;$$
wherein, m is a total number of elements of the target structure body; Gᵢ is the node freedom degree transformation matrix of the i^{th} element; Fᵢ is an element load vector of the i^{th} element Q Nᵢ is an element shape function matrix of the i^{th} element, Nₐ is the shape function at the node of the i^{th} element, and dim is a problem dimension, a=1, 2, 3 . . . , dim; and bis an external load vector of the node of the i^{th} element.

8. The solid structure deformation and damage analysis method based on the quasi-bond finite element method according to claim 7, wherein, in the step S5, the convergence index is equal to ∥F^{t}−F^{t-1}∥/∥F^{t}∥, wherein, F^{t} represents a force matrix of the target structure body obtained in the step S3 in a t^{th} iteration, and F^{t-1} represents a force matrix of the target structure body obtained in the step S3 in a (t−1)^{th} iteration; and
if ∥F^{t}−F^{t-1}∥/∥F^{t}∥<φ is satisfied, the force matrix is converged; and if ∥F^{t}−F^{t-1}∥/∥F^{t}∥<φ is not satisfied, the force matrix is not converged, wherein φ is a given error tolerance value.

9. The solid structure deformation and damage analysis method based on the quasi-bond finite element method according to claim 8, wherein, in the step S5, a calculation method of a variable quantity ΔK̅ of the overall stiffness matrix of the target structure body is as follows:
the structure body is set as an elastic material, the initial node displacement vector u^{trial} is calculated, and then elongations I_{I}^{i,j} of all quasi-bonds are calculated, I_{I}^{i,j}=∥ξ_{I}^{i,j}+η_{I}^{i,j}∥/∥ξ_{I}^{i,j}∥, wherein η_{I}^{i,j} is a relative deformation vector of the quasi-bond ξ_{I}^{i,j}, and ∥g∥ represents a module length of the calculated vector; and
an elongation of a broken quasi-bond is set as 0, then the elongations of all quasi-bonds are sorted from large to small to form a sequence Y, the first M quasi-bonds in the Y are taken for breakage judgment, a sequence of newly added broken quasi-bonds after each iteration is recorded as Y_{c}, if a number of elements in the Y_{c} is 0, ΔK̅ is a zero matrix, and if the number of elements in the Y_{c} is not 0, the quasi-bond breakage weight function μ(ξ, t) in the Y_{c} is set as 0, and a variable quantity ΔK̅ of the overall stiffness matrix is calculated:
$$Δ \overline{K} = - {\sum }_{j ∈ {Y}_{c}} {G}_{j}^{T} {Q}^{j} {G}_{j} ;$$
wherein, Y_{c} is the sequence of the newly added broken quasi-bonds, Gⱼ is a node freedom degree transformation matrix corresponding to the j^{th} quasi-bond in the Y_{c}, and Q^{j} is a bond element stiffness matrix of the j^{th} quasi-bond in the Y_{c}.

10. The solid structure deformation and damage analysis method based on the quasi-bond finite element method according to claim 9, wherein a calculation method of a breakage weight function μ(ξ, t) of the quasi-bond ξ_{I}^{i,j} in the t^{th} iteration is:
$$μ ( ξ , t ) = \{ \begin{matrix}1 , & l < {l}_{c} \\ 0 , & l \geq {l}_{c}\end{matrix} ;$$
wherein, I is an elongation of the quasi-bond, and I_{c} is a given critical elongation;
a strain sampling scope is constructed for any node, the elongation I of the quasi-bond is calculated by using a smoothed strain ε̅_{I}, and calculation steps are as follows:
$$l = n \cdot {\overline{ε}}_{l} \cdot n ;$$
$$[ \begin{matrix}{\overline{ε}}_{l} \\ r\end{matrix} ] = {T}_{l} {U}_{l} ;$$
$${T}_{l} = {( {X}_{l}^{T} {X}_{l} )}^{- 1} {X}_{l}^{T} ;$$
$${X}_{l} = [ \begin{matrix}{x}_{1}^{1} & {x}_{2}^{1} & {x}_{3}^{1} & 1 \\ {x}_{1}^{2} & {x}_{2}^{2} & {x}_{3}^{2} & 1 \\ M & M & M & M \\ {x}_{1}^{v} & {x}_{2}^{v} & {x}_{3}^{v} & 1\end{matrix} ] ;$$
$${U}_{l} = [ \begin{matrix}{u}_{1}^{1} & {u}_{2}^{1} & {u}_{3}^{1} \\ {u}_{1}^{2} & {u}_{2}^{2} & {u}_{3}^{2} \\ M & M & M \\ {u}_{1}^{v} & {u}_{2}^{v} & {u}_{3}^{v}\end{matrix} ] ;$$
wherein, n is a direction vector n=ξ_{I}^{i,j}/∥ξ_{I}^{i,j}∥ of the quasi-bond ξ_{I}^{i,j}, T_{I} is a smoothed strain transformation matrix, U_{I} is a matrix formed by displacements of all nodes in the strain sampling scope at the node I, and X_{I} is a position matrix of all nodes in the strain sampling scope at the node I; and in order to simplify expression, in the matrix, xₐ^{v} represents an a^{th} component of a position vector of a v^{th} node in the sampling scope, and uₐ^{v} represents an a^{th} component of a displacement vector of the v^{th} node in the sampling scope, a=1, 2, 3.
